(19) United States
(12) Patent Application Publication
(10) Pub. No.: US 2023/0239954 A1
(43) Pub. Date: Jul. 27, 2023

(54) COMMUNICATION METHOD AND RELATED DEVICE

(71) Applicant: HUAWEI TECHNOLOGIES CO., LTD., Shenzhen (CN)

(72) Inventors: Jing LIU, Shanghai (CN); Yuanping ZHU, Shanghai (CN); Yulong SHI, Beijing (CN); Fei SUN, Shanghai (CN)

(21) Appl. No.: 18/192,141

(22) Filed: Mar. 29, 2023

Related U.S. Application Data
(63) Continuation of application No. PCT/CN2021/085137, filed on Apr. 1, 2021.

(30) Foreign Application Priority Data
Sep. 30, 2020 (WO) PCT/CN2020/119697
Dec. 19, 2020 (WO) PCT/CN2020/137817

(51) Int. Cl. H04W 76/19; H04W 40/34

(52) U.S. Cl. CPC H04W 76/19; H04W 40/34

(57) ABSTRACT

A communication method and a related device include in response to a first node determining that an RLF occurs on a radio link between the first node and a second node, and there is no other available path between the first node and a destination node, the first node sends first indication information to a third node. The first indication information indicates the RLF or indicates that a link recovery attempt is being made. The second node is a parent node of the first node, and the third node is a child node of the first node; or the second node is a child node of the first node, and the third node is a parent node of the first node, or a donor node connected to the first node.

### CROSS-REFERENCE TO RELATED APPLICATION

This application is a continuation of International Application No. PCT/CN2021/085137, filed on Apr. 1, 2021, which claims priority to International Patent Application No. PCT/CN2020/119697, filed on Sep. 30, 2020 and International Application No. PCT/CN2020/137817, filed on Dec. 19, 2020. All the aforementioned patent applications are hereby incorporated in entirety by reference.

### BACKGROUND

In a relay network, a radio link failure (RLF) occurs on a radio link between a relay node and a parent node. In response to the RLF occurring between the relay node and the parent node, the relay node first attempts to recover the link. In response to the relay node failing to recover the link, the relay node sends RLF indication information to a child node of the relay node, to indicate occurrence of the RLF to the child node, so that the child node triggers a re-routing operation, and transmit to-be-transmitted data via another relay node.

However, in response to successfully performing re-routing, the original relay node still sends the RLF indication information to the child node of the relay node, to trigger the child node to perform re-routing. This causes an unnecessary waste of link resources and unnecessary overheads of air interface resources.

### SUMMARY

In view of this, some embodiments provide a communication method and a related device, to implement proper re-routing in response to an RLF occurring.

Some embodiments provide a communication method. The method includes: In response to a first node determining that an RLF occurs on a radio link between the first node and a second node, and there is no other available path between the first node and a destination node, the first node sends first indication information to a third node. The first indication information indicates the RLF or indicates that a link recovery attempt is being made. The second node is a parent node of the first node, and the third node is a child node of the first node; or the second node is a child node of the first node, and the third node is a parent node of the first node or a donor node connected to the first node.

According to this design, for example, beneficial effects include: A re-routing function of a relay node is fully utilized, to improve data relay stability, and avoid an unnecessary waste of link resources and unnecessary overheads of air interface signaling.

In some embodiments, in response to the second node being a parent node of the first node, and the third node is a child node of the first node, in response to determining that the RLF occurs on the radio link between the first node and the second node and the radio link recovery attempt is being made, and determining that there is no other available path between the first node and the destination node, the first node sends the first indication information to the third node. The first indication information indicates that the link recovery attempt is being made.

According to this design, for example, beneficial effects include: A re-routing function and a link recovery function of a relay node is fully utilized, to improve data relay stability, and avoid an unnecessary waste of link resources and unnecessary overheads of air interface signaling.

In some embodiments, the first node further sends second indication information to the third node, where the second indication information indicates that a path that passes through the first node to the destination node is unavailable.

According to this design, for example, beneficial effects include: The third node obtains more accurate information about the RLF, to implement more efficient and accurate re-routing.

In some embodiments, the second indication information includes a backhaul adaptation protocol (BAP) address of the destination node.

According to this design, for example, beneficial effects include: An indication to the third node that each path that passes through the first node to the destination node are unavailable, so that the third node implements more efficient and accurate re-routing.

In some embodiments, the second indication information includes a routing identity (routing ID) corresponding to the path that passes through the first node to the destination node.

In some embodiments, the second indication information includes a path identity (path ID) corresponding to the path that passes through the first node to the destination node.

In some embodiments, that the second indication information indicates that a path that passes through the first node to the destination node is unavailable includes: The second indication information indicates that each path that passes through the first node to the destination node are unavailable; the second indication information indicates that a path whose corresponding path ID is equal to the path ID included in the second indication information is unavailable in each path that passes through the first node to the destination node; or the second indication information indicates that a path whose corresponding routing ID is equal to the routing ID included in the second indication information is unavailable in each path that passes through the first node to the destination node.

According to this design, for example, beneficial effects include: An indication to the third node that which paths that pass through the first node to the destination node are unavailable, so that the third node implements more efficient and accurate re-routing.

In some embodiments, in response to the second node being a child node of the first node, and the third node is a donor node connected to the first node, the second indication information includes an identifier of the second node.

In some embodiments, that the second indication information indicates that a path that passes through the first node to the destination node is unavailable includes: The second indication information indicates that a path that includes the direct radio link between the first node and the second node is unavailable in each path that passes through the first node to the destination node.

According to this design, for example, beneficial effects include: In response to receiving the identifier of the second node from the first node, the donor node (namely, the third node) accurately determines a case in which the RLF occurs, so that the third node implements more efficient and accurate re-routing.

Some embodiments provide a communication method. The method includes: In response to a third node receiving second indication information from a first node, where the second indication information indicates that a path that passes through the first node to a destination node is unavailable, the third node determines to route data to the destination node through another path.

In some embodiments, the third node further receives first indication information from the first node, where the first indication information indicates an RLF or indicates that a link recovery attempt is being made.

In some embodiments, the second indication information includes a BAP address of the destination node, a routing ID corresponding to the path that passes through the first node to the destination node, or a path identity (path ID) corresponding to the path that passes through the first node to the destination node.

In some embodiments, the other path does not include the first node, a routing ID of the other path is not equal to the routing ID included in the second indication information, or a path ID of the other path is not equal to the path ID included in the second indication information.

In some embodiments, the second indication information includes an identifier of a second node, the second node is a child node of the first node, and the RLF occurs on a radio link between the first node and the second node.

In some embodiments, a routing ID of the other path is not equal to a routing ID corresponding to a path that passes through the first node to the destination node and that includes the direct radio link between the first node and the second node.

In some embodiments, in response to the third node receiving third indication information from the first node, where the third indication information indicates that radio link recovery succeeds, the third node stops routing the data to the destination node through the other path used for re-routing.

According to this design, for example, beneficial effects include: The third node stops re-routing in time, and recover using, to route data, a source path used before the RLF is notified (in other words, recover using original routing configuration information to route data), so that processing complexity of an upstream node or a downstream node of the third node is reduced.

Some embodiments provide a communication method. The method includes: A first node receives a first message from a master base station of a fourth node, where the first message requests to add the first node as a secondary base station of the fourth node. The first message includes: a physical cell identifier PCI of a cell that is of a second node and that is accessed by the fourth node and a cell radio network temporary identifier C-RNTI of the fourth node in the cell of the second node; or an identifier of a third node and an identifier of the fourth node on an interface between the third node and the first node. The third node is a source secondary base station of the fourth node, and the fourth node is a downstream node of the second node. The first node further obtains context information of the fourth node.

According to the method, for example, beneficial effects include: Because the context information of the fourth node has been cached on the first node, the message sent by the master base station to the first node does not carry the context information of the fourth node again, to reduce air interface overheads. An identifier of the fourth node, for example, the PCI of the cell that is of the second node and that is accessed by the fourth node and the C-RNTI of the fourth node in the cell of the second node, is carried in the message sent by the master base station to the first node. In this way, the first node obtains the context information of the fourth node based on the identifier of the fourth node in the first message, and then the first node becomes a new secondary base station of the fourth node to provide a service for the fourth node. This avoids data interruptions of the fourth node.

In some embodiments, before receiving the first message, the method further includes: The first node receives a second message from the second node, where the second message requests to establish or re-establish a radio resource control RRC connection to the second node. Then, the first node sends a third message to the third node, where the third message requests to obtain context information related to the second node. Then, the first node receives a fourth message from the third node, where the fourth message includes the context information related to the second node. The third node sends a fifth message to the second node, where the fifth message is used to establish or re-establish the RRC connection to the second node.

In some embodiments, the fifth message includes information used to update a cell served by the second node.

In some embodiments, the information used to update the cell served by the second node includes a global cell identifier CGI and/or a cell identity of the cell of the second node in response to the second node being connected to the first node.

In some embodiments, the context information related to the second node includes at least one of the following: context information of the second node, topology information between the second node and the fourth node, the context information of the fourth node, indication information indicating whether the second node is a wireless backhaul device, or indication information indicating whether the fourth node is a wireless backhaul device.

In some embodiments, the context information of the fourth node includes the PCI and the C-RNTI.

In some embodiments, the context information of the fourth node includes the identifier of the third node and the identifier of the fourth node on the interface between the third node and the first node.

Some embodiments provide a communication method. The method includes: A master base station of a fourth node receives a sixth message from a third node, where the sixth message requests to use a first node as a target secondary base station of the fourth node, and the third node is a source secondary base station of the fourth node. Then, the master base station sends a first message to the first node, where the first message requests to add the first node as a secondary base station of the fourth node, and the first message includes a physical cell identifier PCI of a cell that is of a second node and that is accessed by the fourth node and a cell radio network temporary identifier C-RNTI of the fourth node in the cell of the second node; or the first message includes an identifier of the third node and an identifier of the fourth node on an interface between the third node and the first node.

According to the method, for example, beneficial effects include: The second node is re-established from the source secondary base station to a destination secondary base station, to reduce impact on a downstream node (the fourth node) of the second node, and ensure normal working of the downstream node of the second node.

Some embodiments provide a communication method. The method includes: A first node determines first information. The first node determines, based on the first information, whether to trigger re-routing.

In some embodiments, the first node determines the first information. The first information includes a first threshold. In this case, the first node triggers re-routing in response to a quantity of transmission/retransmission times of a data packet of the first node reaching/exceeding the first threshold. Alternatively, the first information includes a configuration of a timer, and the configuration of the timer includes timer duration. In this case, the first node triggers re-routing in response to the timer expires and a data packet of the first node has not been successfully sent.

In some embodiments, the first node receives the first information from a third node. The first information includes a first threshold, and the first information indicates to trigger re-routing in response to a quantity of transmission/retransmission times of a data packet of the first node reaching/exceeding the first threshold. Alternatively, the first information includes a configuration of a timer, and the first information indicates to trigger re-routing in response to the timer expiring and the data packet of the first node has not been successfully sent.

In some embodiments, the first node determines, based on the first information, whether to trigger uplink re-routing, where the data packet of the first node is an uplink data packet. The third node is a donor node connected to the first node or an upstream node.

In some embodiments, the first node determines, based on the first information, whether to trigger downlink re-routing, where the data packet of the first node is a downlink data packet. The third node is a donor node connected to the first node. In some embodiments, the data packet of the first node is a BAP layer/RLC layer/MAC layer/PHY layer data packet.

In some embodiments, in response to the data packet of the first node being the RLC layer data packet, the first threshold needs to be less than a maximum retransmission threshold of the RLC layer.

In some embodiments, in response to the data packet of the first node being the RLC layer data packet, timer duration needs to meet the following condition: Before the timer expires, a quantity of transmission/retransmission times of the RLC layer data packet of the first node is less than the maximum retransmission threshold of the RLC layer.

In some embodiments, the maximum retransmission threshold of the RLC layer is used by the first node to determine whether a radio link failure occurs. The maximum retransmission threshold of the RLC layer is configured by the donor node for the first node by using an RRC message.

Some embodiments provide a communication method. The method includes: In response to a first node determining that radio links between the first node and second nodes are unavailable, the first node sends first indication information to a third node. The first indication information indicates an RLF or indicates that a link recovery attempt is being made. The second node is a child node of the first node, and the third node is a parent node of the first node or a donor node connected to the first node; or the second node is a parent node of the first node, and the third node is a child node of the first node.

In some embodiments, in response to determining that the radio links between the first node and the second nodes are unavailable, and the link recovery attempt is being made, the first node sends the first indication information to the third node. The first indication information indicates that the link recovery attempt is being made.

In some embodiments, the first node further sends second indication information to the third node, where the second indication information indicates that the first node is unavailable, or indicates that channels between the first node and the second nodes are unavailable.

In some embodiments, the second indication information includes a backhaul adaptation protocol (BAP) address of the first node.

In some embodiments, the second indication information includes an identifier of a second backhaul RLC channel, and there is a correspondence between the second backhaul RLC channel and a first backhaul RLC channel. The first backhaul RLC channel includes backhaul RLC channels between the first node and the second node, and the second backhaul RLC channel includes backhaul RLC channels between the first node and the third node.

In some embodiments, the first node maps data from the first backhaul RLC channel to the second backhaul RLC channel based on the correspondence between the second backhaul RLC channel and the first backhaul RLC channel, or the first node maps data from the second backhaul RLC channel to the first backhaul RLC channel based on the correspondence.

In some embodiments, in response to determining that the RLF occurs on the radio links between the first node and the second nodes, a DU of the first node sends third indication information to an MT of the first node, where the third indication information indicates the MT of the first node to send the first indication information to the third node.

In some embodiments, the first indication information is carried in a BAP control PDU or a MAC CE.

Some embodiments provide a communication method. The method includes: In response to a first node determining that a first backhaul RLC channel between the first node and a second node is unavailable, the first node sends first indication information to a third node. The first indication information indicates that a second backhaul RLC channel between the first node and the third node is unavailable, or an attempt is being made to recover the backhaul RLC channel There is a correspondence between the second backhaul RLC channel and the first backhaul RLC channel. The second node is a child node of the first node, and the third node is a parent node of the first node or a donor node connected to the first node; or the second node is a parent node of the first node, and the third node is a child node of the first node.

In some embodiments, in response to determining that the first backhaul RLC channel between the first node and the second node is unavailable, and the attempt is being made to recover the backhaul RLC channel, the first node sends the first indication information to the third node. The first indication information indicates that the attempt is being made to recover the backhaul RLC channel.

In some embodiments, the first indication information includes an identifier of the second backhaul RLC channel.

In some embodiments, the first node maps data from the first backhaul RLC channel to the second backhaul RLC channel based on the correspondence between the second backhaul RLC channel and the first backhaul RLC channel, or the first node maps data from the second backhaul RLC channel to the first backhaul RLC channel based on the correspondence.

In some embodiments, the second node is located between the first node and a master base station/a master donor node of the first node, or is located between the first node and a secondary donor node of the first node; or the second node is a master base station/a master donor node of the first node; or the second node is a secondary donor node of the first node.

Some embodiments provide a communication apparatus. The apparatus includes a module configured to perform the method in any one of the embodiments.

Some embodiments provide a communication apparatus, including a processor and a memory. The processor is coupled to the memory, and the processor is configured to implement the method in any one of the embodiments.

Some embodiments provide a communication apparatus, including at least one processor and an interface circuit. The interface circuit is configured to: receive a signal from a communication apparatus other than the communication apparatus and transmit the signal to the processor, or send a signal from the processor to a communication apparatus other than the communication apparatus. The processor is configured to implement, by using a logic circuit or executing code instructions, the method in any one of the embodiments.

In some embodiments, the apparatus is a chip or an integrated circuit in a node in the method in any one of the embodiments.

Optionally, the communication apparatus further includes at least one memory, and the memory stores related program instructions.

Some embodiments provide a communication apparatus. The apparatus has a function or an operation for implementing the method in any one of the embodiments, and the function or the operation is implemented by hardware, or is implemented by hardware by executing corresponding software. The hardware or the software includes one or more units (modules) corresponding to the foregoing functions or operations, for example, includes a transceiver unit and a processing unit.

Some embodiments provide a computer-readable storage medium. The computer-readable storage medium stores program instructions, and in response to the program instructions being run, the communication apparatus is enabled to implement the method in any one of the embodiments.

Some embodiments provide a computer program product. The computer program product includes program instructions, and in response to the program instructions being executed, the method in any one of the embodiments.

Some embodiments provide a chip. The chip is configured to implement the method in any one of the embodiments.

Some embodiments provide a communication system. The communication system includes at least one communication apparatus in any one of the embodiments.

### BRIEF DESCRIPTION OF DRAWINGS

The accompanying drawings, which is included and constitute a part of the embodiments, together show examples, or features and aspects, and are used to explain principles of the embodiments. The accompanying drawings in the following descriptions show some embodiments, and a person of ordinary skill in the art is able to derive other drawings from these accompanying drawings without creative efforts.

FIG. 1 is a schematic diagram of a possible communication system according to some embodiments;

FIG. 2 is a schematic diagram of an IAB donor according to some embodiments;

FIG. 3 is a schematic diagram of a control plane protocol stack in an IAB network according to some embodiments;

FIG. 4 is a schematic diagram of a user plane protocol stack in an IAB network according to some embodiments;

FIG. 5 is a schematic diagram of IAB node networking according to some embodiments;

FIG. 6A is a schematic diagram of a communication method according to some embodiments;

FIG. 6B is a schematic diagram of a communication method according to some embodiments;

FIG. 6C is a schematic diagram of a communication method according to some embodiments;

FIG. 6D is a schematic diagram of a communication method according to some embodiments;

FIG. 6E is a schematic diagram of a communication method according to some embodiments;

FIG. 6F is a schematic diagram of a communication method according to some embodiments;

FIG. 7 is a schematic diagram of a communication method according to some embodiments;

FIG. 8 is a schematic diagram of a communication method according to some embodiments;

FIG. 9 is a schematic block diagram of a communication apparatus according to some embodiments;

FIG. 10 is a schematic block diagram of a communication apparatus according to some embodiments;

FIG. 11 is a schematic block diagram of a communication apparatus according to some embodiments;

FIG. 12 is a schematic block diagram of a communication apparatus according to some embodiments; and

FIG. 13 is a schematic block diagram of an apparatus according to some embodiments.

### DESCRIPTION OF EMBODIMENTS

Compared with a 4th generation mobile communication system or a long term evolution (LTE) system, a 5th generation (5G) mobile communication system or a new radio (NR) system imposes stricter conditions on various network performance indicators in an all-round way. For example, a capacity indicator is increased by 1000 times, wider coverage is desirable, and ultra-high reliability and ultra-low latency is desirable. In some embodiments, in consideration of rich frequency resources on high-frequency carriers, networking using high-frequency small cells is increasingly popular in hotspot areas, to meet an ultra-high capacity condition of 5G. The high-frequency carriers have a poor propagation characteristic, are severely attenuated due to blocking, and have small coverage. Therefore, a large quantity of small cells need to be densely deployed. Correspondingly, to provide fiber backhaul for the large quantity of densely deployed small cells is costly, and construction is difficult. Therefore, an economical and convenient backhaul solution is desirable. In some embodiments, from a perspective of a wide coverage condition, to deploy optical fibers to provide network coverage in some remote areas is difficult and costly. Therefore, a flexible and convenient access and backhaul solution also needs to be designed. A wireless backhaul device provides an idea for resolving the foregoing two problems. An access link and a backhaul link of the wireless backhaul device each use a wireless transmission solution, to avoid optical fiber deployment. The wireless backhaul device is a relay node (RN), an integrated access and backhaul (IAB) node, or another device that provides a wireless backhaul function. This is not limited in the embodiments. In an IAB network, an IAB node serves as a wireless backhaul device, and provides a wireless access service for user equipment (UE). Service data of the UE is transmitted by the IAB node connecting to a donor node or a donor base station over a wireless backhaul link. An antenna is shared by using the IAB node for access and backhaul, to reduce a quantity of antennas of a base station.

The following describes the embodiments with reference to the accompanying drawings. Features or content marked by dashed lines in the accompanying drawings are understood as optional operations or optional structures in the embodiments.

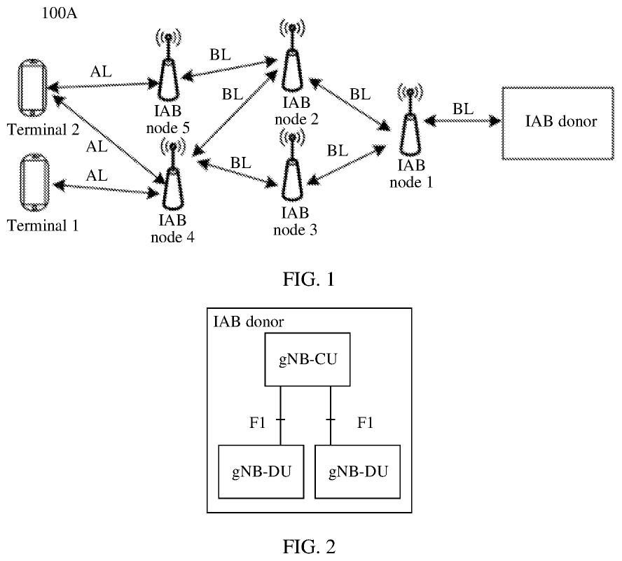

User equipment in FIG. 1 is an access terminal device, a subscriber unit, a subscriber station, a mobile station, a remote station, a remote terminal device, a mobile device, a user terminal device, a wireless terminal device, a user agent, a user apparatus, or the like. The user equipment alternatively is a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, a wearable device (such as a smart watch or a smart band), smart furniture or a home appliance, a terminal device in a 5G network, a terminal device in a future evolved public land mobile network (PLMN), a vehicle device in vehicle-to-everything (V2X), customer premises equipment (CPE), or the like. An implementation form of the user equipment is not limited the embodiments.

An IAB node in FIG. 1 includes a mobile termination (MT) and a distributed unit DU (DU). For a parent node of the IAB node, the IAB node is considered as a terminal device, namely, a role of the MT. For a subordinate device of the IAB node (where the subordinate device is another IAB child node or common UE), the IAB node is considered as a network device, namely, a role of the DU. In some embodiments, the IAB node is used as an example for each node in FIG. 1, and each IAB node is replaced with a common relay node (RN).

An IAB donor in FIG. 1 is a donor base station, and the IAB donor is referred to as a DgNB (namely, a donor gNodeB) for short in a 5G network. The IAB donor is a complete entity, or exists in a form in which a central unit (CU) (Donor-CU or gNB-CU for short) and a distributed unit (DU) (Donor-DU or gNB-DU for short) are separated. As shown in FIG. 2, the IAB donor is a gNB located in a 5G radio access network (5G RAN). The IAB donor includes the gNB-CU and the gNB-DU. The gNB-CU is connected to the gNB-DU through an F1 interface, and the F1 interface further includes a control plane interface (F1-C) and a user plane interface (F1-U). The CU is connected to a core network through a next generation (NG) interface. The gNB-CU or the donor-CU alternatively exists in a form in which a user plane (UP) (CU-UP for short) and a control plane (CP) (CU-CP for short) are separated. In other words, the gNB-CU or the donor-CU includes the CU-CP and the CU-UP. One gNB-CU includes one gNB-CU-CP and at least one gNB-CU-UP. Alternatively, one donor-CU includes one donor-CU-CP and at least one donor-CU-UP.

The IAB node is connected to the core network via the IAB donor. For example, in a standalone (SA) 5G architecture, the IAB node is connected to a 5GC via the IAB donor. In a dual connectivity (DC) or multi-connectivity (MC) 5G architecture (for example, in a non-standalone (NSA) or an NR-NR DC scenario), on a primary path, the IAB node is connected to an evolved packet core (EPC) via an evolved base station (eNB), or is connected to the 5G core via the IAB donor.

To ensure service transmission reliability, in an IAB network, multi-hop IAB node networking and multi-connectivity IAB node networking are supported. Therefore, there is a plurality of transmission paths between a terminal and an IAB donor. On one path, there is a determined hierarchical relationship between IAB nodes, and between an IAB node and an IAB donor connected to the IAB node. Each IAB node considers, as a parent node, a node providing a backhaul service for the IAB node. Correspondingly, each IAB node is considered as a child node of the parent node of the IAB node.

For example, refer to FIG. 1. A parent node of an IAB node 1 is an IAB donor, the IAB node 1 is a parent node of an IAB node 2 and an IAB node 3, both the IAB node 2 and the IAB node 3 are parent nodes of an IAB node 4, and a parent node of an IAB node 5 is the IAB node 2. An uplink data packet of the terminal is transmitted to the IAB donor via one or more IAB nodes, and a downlink data packet is sent by the IAB donor to the terminal via the one or more IAB nodes. There are two available paths for transmitting a data packet between a terminal 1 and the IAB donor: the terminal 1→the IAB node 4→the IAB node 3→the IAB node 1→the IAB donor, and the terminal 1→the IAB node 4→the IAB node 2→the IAB node 1→the IAB donor. There are three available paths for transmitting a data packet between a terminal 2 and the IAB donor: the terminal 2→the IAB node 4→the IAB node 3→the IAB node 1→the IAB donor, the terminal 2→the IAB node 4→the IAB node 2→the IAB node 1→the IAB donor, and the terminal 2→the IAB node 5→the IAB node 2→the IAB node 1→the IAB donor.

To ensure normal data transmission between the terminal and the IAB donor, the IAB donor needs to configure a routing table for each IAB node, in other words, configure next-hop nodes corresponding to different paths. In addition, the IAB donor needs to determine a transmission path corresponding to data transmission. In other words, a transmission path is determined before data transmission. The transmission path is referred to as a primary path. Routing transmission is performed on data between the terminal and the IAB donor through the primary path, and another path is referred to as a backup path. The backup path is used for re-routing in response to the primary path being unavailable, for example, in response to an RLF occurring on a link on the primary path. For example, as shown in FIG. 1, the IAB donor configures a primary path for data transmission of the terminal 2 as: the terminal 2→the IAB node 4→the IAB node 2→the IAB node 1→the IAB donor. In response to the IAB node 2 detecting that the RLF occurs on a link between the IAB node 2 and the IAB node 1 and the link is unable to be recovered, the IAB node 2 sends one piece of RLF indication information to the IAB node 4. Based on the indication information, the IAB node 4 triggers data re-routing, and temporarily transmit, through the backup path, uplink data received from the terminal 2. The path is: the terminal 2→the IAB node 4→the IAB node 3→the IAB node 1→the IAB donor.

To ensure stable data transmission between the terminal and the IAB donor, a radio link recovery mechanism is introduced. After the RLF occurs between two nodes, an attempt is made to recover a radio link between the two nodes. For example, as shown in FIG. 1, after the RLF occurs between the IAB node 5 and the IAB node 2, the IAB node 5 attempts to perform radio link recovery, for example, perform RRC re-establishment in another cell of the IAB node 2, to recover a radio link between the IAB node 5 and the IAB node 2.

Each intermediate IAB node on an uplink path from the IAB node to the IAB donor is referred to as an upstream node of the IAB node. For example, both the IAB node 1 and the IAB node 2 in FIG. 1 is referred to as upstream IAB nodes of the IAB node 5. Each intermediate IAB node on a downlink path from the IAB node to the terminal is referred to as a downstream node of the IAB node. For example, the IAB node 2, the IAB node 3, the IAB node 4, and the IAB node 5 in FIG. 1 is referred to as downstream nodes of the IAB node 1. The downstream node includes a child node, a child node (or referred to as a grandchild node) of the child node, and the like. The downstream node is another IAB node or a terminal. For example, the terminal 1 in FIG. 1 is referred to as a downstream node of the IAB node 4, the IAB node 4 and the IAB node 5 is referred to as downstream nodes of the IAB node 1, and the terminal 1 and the terminal 2 is referred to as downstream nodes of the IAB node 1.

In some embodiments, in the IAB network, one transmission path between the terminal and the IAB donor includes one or more IAB nodes. Each IAB node needs to maintain a wireless backhaul link for a parent node, and further needs to maintain a radio link with a child node. in response to the child node of the IAB node being a terminal, a radio access link exists between the IAB node and the child node (namely, the terminal). in response to the child node of the IAB node is another IAB node, a wireless backhaul link exists between the IAB node and the child node (namely, the other IAB node). For example, refer to FIG. 1. On the path “the terminal 1→the IAB node 4→the IAB node 3→the IAB node 1→the IAB donor”, the terminal 1 accesses the IAB node 4 through a radio access link, the IAB node 4 is connected to the IAB node 3 through a wireless backhaul link, the IAB node 3 is connected to the IAB node 1 through a wireless backhaul link, and the IAB node 1 is connected to the IAB donor through a wireless backhaul link.

The foregoing IAB networking scenario is an example. In an IAB scenario in which multi-hop and multi-connectivity are combined, there are more other possible IAB networking scenarios. For example, an IAB donor and an IAB node connected to another IAB donor form dual connectivity to serve a terminal. The networking scenarios are not listed one by one herein.

In some embodiments, an access IAB node is an IAB node accessed by the terminal, and the intermediate IAB node is an IAB node that provides a wireless backhaul service for the terminal or the IAB node. For example, refer to FIG. 1. On the path “the terminal 1→the IAB node 4→the IAB node 3→the IAB node 1→the IAB donor”, the IAB node 4 is an accessed IAB node, and the IAB node 3 and the IAB node 1 are intermediate IAB nodes. In some embodiments, an IAB node is an access IAB node for a terminal that accesses the IAB node, and is an intermediate IAB node for a terminal that accesses another IAB node. Therefore, whether an IAB node is specifically an access IAB node or an intermediate IAB node is not fixed, and needs to be determined based on an application scenario.

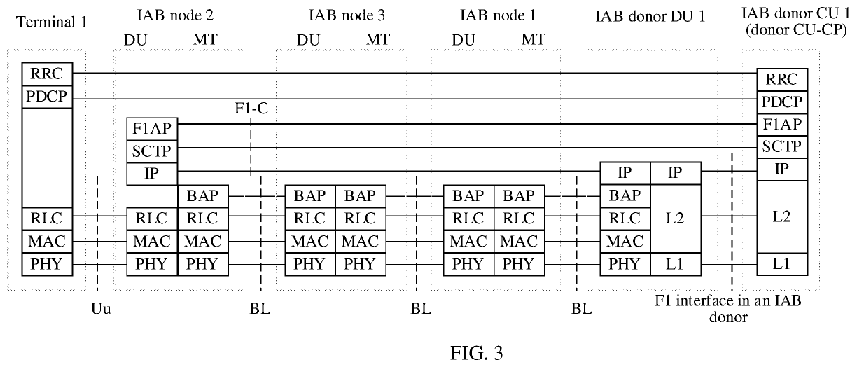

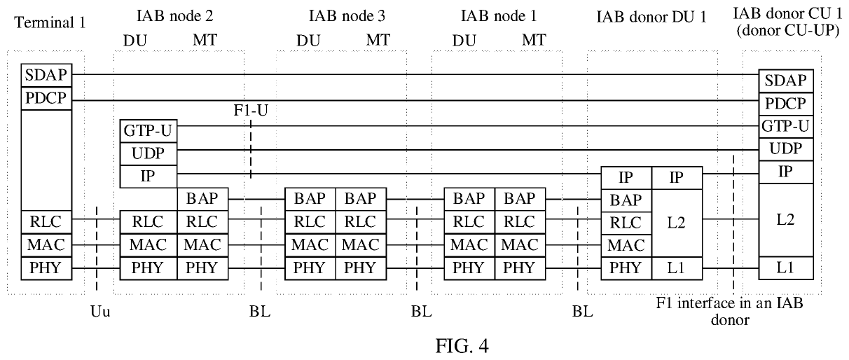

FIG. 3 and FIG. 4 are respectively a schematic diagram of a control plane protocol stack and a schematic diagram of a user plane protocol stack in an IAB network according to the embodiments. The following provides descriptions with reference to FIG. 3 and FIG. 4.

For a control plane, as shown in FIG. 3, a Uu interface is established between a terminal 1 and an IAB2-DU, and peer protocol layers include an RLC layer, a MAC layer, and a PHY layer. An F1-C interface is established between the IAB2-DU and an IAB donor CU 1, and peer protocol layers include an F1 application protocol (F1 AP) layer and a stream control transmission protocol (SCTP) layer. An IAB donor DU 1 is connected to the IAB donor CU 1 in a wired manner, and peer protocol layers include an internet protocol (IP) layer, an L2, and an L1. BLs are established between an IAB node 2 and an IAB node 3, between the IAB node 3 and an IAB node 1, and between the IAB node 1 and the IAB donor DU 1, and peer protocol layers include a backhaul adaptation protocol (BAP) layer, an RLC layer, a MAC layer, and a PHY layer. In addition, peer RRC layers and peer PDCP layers are established between the terminal 1 and the IAB donor CU 1, and peer IP layers are established between the IAB2-DU and the IAB donor DU 1.

In some embodiments, compared with a control plane protocol stack of a single air interface, in the control plane protocol stack in the IAB network, a DU of an access IAB node implements functions (namely, functions of establishing a peer RLC layer, a peer MAC layer, and a peer PHY layer with the terminal and establishing a peer F1 AP layer and a peer SCTP layer with a CU) of a gNB-DU of the single air interface. In some embodiments, the DU of the access IAB node in the IAB network implements the function of the gNB-DU of the single air interface, and the IAB donor CU implements a function of a gNB-CU of the single air interface.

On the control plane, an RRC message is encapsulated in an F1AP message between the access IAB node and the IAB donor CU for transmission. Specifically, in an uplink direction, the terminal 1 encapsulates the RRC message in a PDCP protocol data unit (PDU), and sends the PDCP protocol data unit to the IAB2-DU after processing is sequentially performed at the RLC layer, the MAC layer, and the PHY layer. The IAB2-DU obtains the PDCP PDU after processing is sequentially performed at the PHY layer, the MAC layer, and the RLC layer, encapsulates the PDCP PDU in the F1 AP message, and obtains an IP packet after processing is sequentially performed at the SCTP layer and the IP layer. An IAB2-MT sends the IP packet to an IAB3-DU after processing is separately performed at the BAP layer, the RLC layer, the MAC layer, and the PHY layer. The IAB3-DU obtains the IP packet after processing is sequentially performed at the PHY layer, the MAC layer, the RLC layer, and the BAP layer. Then, an IAB3-MT sends the IP packet to an IAB1-DU by using an operation similar to that of the IAB2-MT. Similarly, an IAB1-MT sends the IP packet to the IAB donor DU 1. After obtaining the IP packet through parsing, the IAB donor DU 1 sends the IP packet to the IAB donor CU 1. The IAB donor CU 1 obtains the RRC message after processing is sequentially performed on the IP packet at the SCTP layer, the F1 AP layer, and the PDCP layer. Operations in a downlink direction are similar. Details are not described herein again.

For a user plane, as shown in FIG. 4, a Uu interface is established between a terminal 1 and an IAB2-DU, and peer protocol layers include an RLC layer, a MAC layer, and a PHY layer. An F1-U interface is established between the IAB2-DU and an IAB donor CU 1, and peer protocol layers include a GPRS tunnelling protocol for the user plane (GTP-U) layer and a user datagram protocol (UDP) layer. An IAB donor DU 1 is connected to the IAB donor CU 1 in a wired manner, and peer protocol layers include an IP layer, an L2, and an L1. BLs are established between an IAB node 2 and an IAB node 3, between the IAB node 3 and an IAB node 1, and between the IAB node 1 and the IAB donor DU 1, and peer protocol layers include a BAP layer, an RLC layer, a MAC layer, and a PHY layer. In addition, peer SDAP layers and peer PDCP layers are established between the terminal 1 and the IAB donor CU 1, and peer IP layers are established between the IAB2-DU and the IAB donor DU 1.

In some embodiments, compared with a user plane protocol stack of a single air interface, in the user plane protocol stack in the IAB network, a DU of an access IAB node implements some of functions (namely, functions of establishing a peer RLC layer, a peer MAC layer, and a peer PHY layer with the terminal and establishing a peer GTP-U layer and a peer UDP layer with the IAB donor CU 1) of a gNB-DU of the single air interface. In some embodiments, the DU of the access IAB node implements the function of the gNB-DU of the single air interface, and the IAB donor CU implements a function of a gNB-CU of the single air interface.

On the user plane, a PDCP data packet is encapsulated in a GTP-U tunnel between the access IAB node and the IAB donor CU for transmission. The GTP-U tunnel is established on the F1-U interface.

FIG. 3 and FIG. 4 are described by using the protocol stacks in the IAB scenario shown in FIG. 1 as examples. In some embodiments, one IAB node plays one or more roles. The IAB node is configured to have one or more protocol stacks of the one or more roles. Alternatively, the IAB node is configured to have one protocol stack, and for different roles of the IAB node, protocol layers corresponding to different roles in the protocol stacks are used for processing. The following provides descriptions by using an example in which the IAB node has the protocol stacks of the one or more roles.

(1) Protocol Stack of a Common Terminal

In response to accessing the IAB network, the IAB node plays a role of a common terminal. In this case, an MT of the IAB node has a protocol stack of the common terminal, for example, the protocol stack, namely, the RRC layer, the PDCP layer, the RLC layer, the MAC layer, and the PHY layer of the terminal 1 in FIG. 3 and FIG. 4. On a control plane, an RRC message of the IAB node is encapsulated in an F1AP message between a parent node of the IAB node and an IAB donor CU for transmission. On a user plane, a PDCP data packet of the IAB node is encapsulated in a GTP-U tunnel between a parent node of the IAB node and an IAB donor CU for transmission.

In addition, after the IAB node accesses the IAB network, the IAB node still plays a role of the common terminal, for example, transmit an uplink data packet and/or a downlink data packet (for example, an OAM data packet) of the IAB node with an IAB donor, and perform measurement through the RRC layer.

(2) Protocol Stack of an Access IAB Node

After the IAB node accesses the IAB network, the IAB node provides an access service for a terminal, to play a role of an access IAB node. In this case, the IAB node has a protocol stack of the access IAB node, for example, the protocol stack of the IAB node 2 in FIG. 3 and FIG. 4.

In this case, there is two protocol stacks on an interface of the IAB node for a parent node of the IAB node. One is a protocol stack of a common terminal, and the other is a protocol stack (namely, the protocol stack of the access IAB node) that provides a backhaul service for the terminal. Optionally, same protocol layers of the two protocol stacks are shared. For example, the two protocol stacks correspond to a same RLC layer, a same MAC layer, a same PHY layer, or a same BAP layer.

(3) Protocol Stack of an Intermediate IAB Node

After the IAB node accesses the IAB network, the IAB node plays a role of an intermediate IAB node. In this case, the IAB node has a protocol stack of the intermediate IAB node, for example, the protocol stack of the IAB node 3 or the IAB node 1 in FIG. 3 and FIG. 4.

In this case, there is two protocol stacks on an interface of the IAB node for a parent node of the IAB node. One is a protocol stack of a common terminal, and the other is a protocol stack (namely, the protocol stack of the intermediate IAB node) that provides a backhaul service for an IAB child node. Optionally, same protocol layers of the two protocol stacks are shared. For example, the two protocol stacks correspond to a same RLC layer, a same MAC layer, a same PHY layer, or a same BAP layer.

In addition, the IAB node plays roles of an access IAB node and an intermediate IAB node at the same time. For example, the IAB node is an access IAB node for some terminals and an intermediate IAB node for other terminals. In this case, the IAB node is configured to have three protocol stacks: One is the protocol stack of the common terminal, one is the protocol stack of the access IAB node, and one is the protocol stack of the intermediate IAB node. Optionally, same protocol layers of the three protocol stacks are shared. For example, the three protocol stacks correspond to a same RLC layer, a same MAC layer, a same PHY layer, or a same BAP layer.

FIG. 3 and FIG. 4 are described by using the IAB network as an example. Content in FIG. 3 and FIG. 4 is also applicable to another type of relay network other than the IAB network. For a control plane protocol stack architecture of the relay network, refer to FIG. 3. For a user plane protocol stack architecture of the relay network, refer to FIG. 4. The IAB node in FIG. 3 and FIG. 4 is replaced with a relay. For example, the IAB node 2 is replaced with a relay node 2, the IAB node 3 is replaced with a relay node 3, the IAB node 1 is replaced with a relay node 1, and the IAB donor 1 is replaced with a donor node 1. The donor node has a protocol stack including the CU and the DU. Other content is the same as the content described in FIG. 3 and FIG. 4. For details, refer to the descriptions in FIG. 3 and FIG. 4. Details are not described herein again.

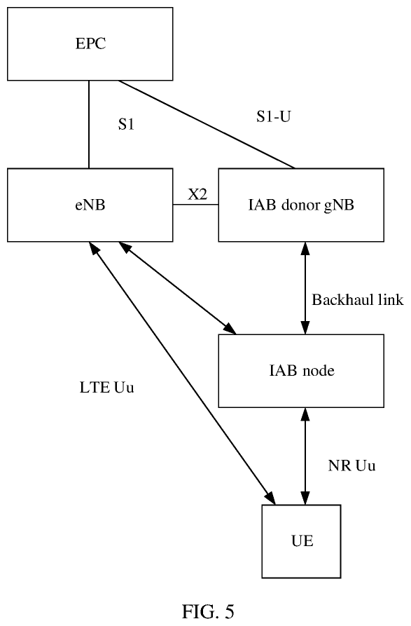

The IAB network shown in FIG. 1 is considered as a schematic diagram of IAB standalone networking, and the IAB network further supports non-standalone (NSA) networking. FIG. 5 is a schematic diagram of IAB non-standalone networking. An IAB node supports dual connectivity, namely, EN-DC (E-UTRAN NR dual connectivity) of 4G and 5G networks, and an LTE base station eNB is a master base station (master eNB, MeNB), which provides an LTE air interface (LTE Uu) connection for the IAB node, and establishes an S1 interface with a 4G core network evolved packet core (EPC) for user plane and control plane transmission. An IAB donor is a secondary base station/a secondary donor node, which provides an NR air interface (NR Uu) connection for the IAB node, and establishes the S1 interface with the core network EPC for user plane transmission. Similarly, UE also supports EN-DC. The UE is connected to the master base station eNB through an LTE Uu interface, accesses the IAB node through an NR Uu interface, and is connected to the secondary base station/the secondary donor node IAB donor via the IAB node. The IAB non-standalone networking scenario in the embodiments further is referred to as an IAB EN-DC networking scenario. In response to the UE or the IAB node changing the secondary base station/the secondary donor node, the secondary base station/the secondary donor node before the change is referred to as a source secondary base station/a source secondary donor node, and a changed secondary base station/a changed secondary donor node is referred to as a target secondary base station/a target secondary donor node.

FIG. 5 is an example of networking, and the NSA scenario of the IAB network also supports multi-hop IAB networking. For example, the UE in FIG. 5 is another IAB node. In other words, the IAB node is connected to the IAB donor through a multi-hop wireless backhaul link. This is not limited the embodiments. The NSA scenario of the IAB network also supports NR-NR DC. For example, in FIG. 5, the master base station eNB alternatively is a master donor node IAB donor. In other words, the IAB node further supports dual connectivity of 5G and 5G networks. In some embodiments, an MT of the IAB node is referred to as an IAB-MT for short, a DU of the IAB node is referred to as an IAB-DU for short, a CU of the IAB donor is referred to as a donor-CU for short, and a DU of the IAB donor is referred to as a donor-DU for short.

In some embodiments, the IAB donor connected to the IAB node is referred to as an IAB donor of the IAB node for short. The IAB node directly accesses the IAB donor, or the IAB node is connected to the IAB donor via another IAB node.

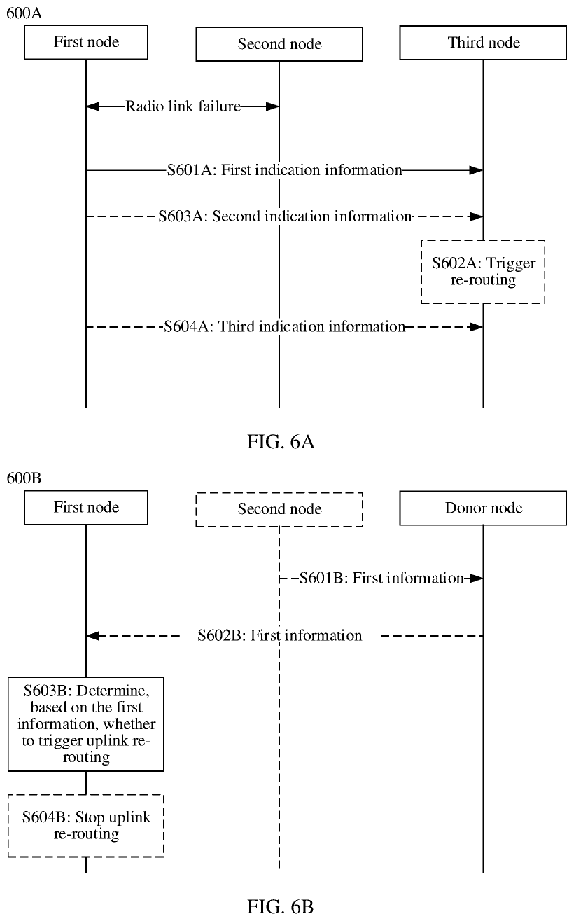

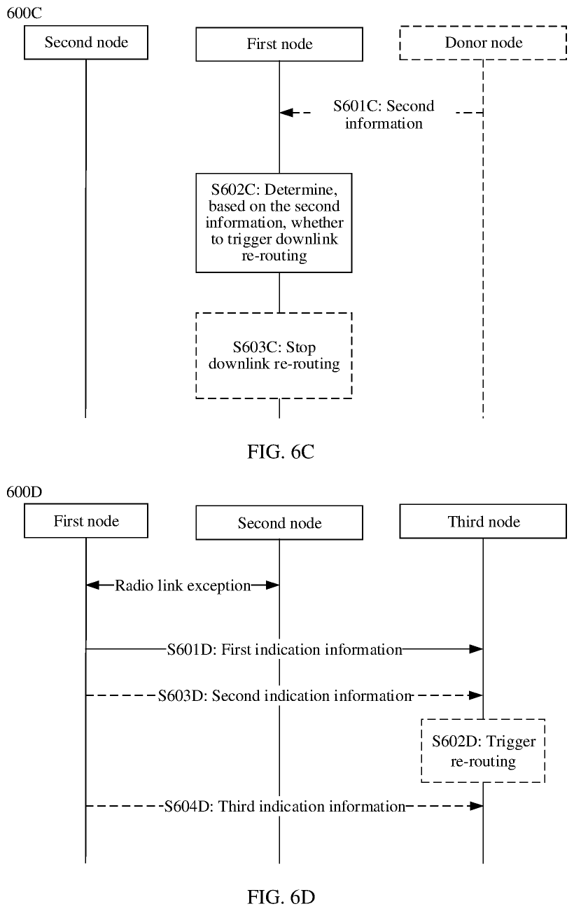

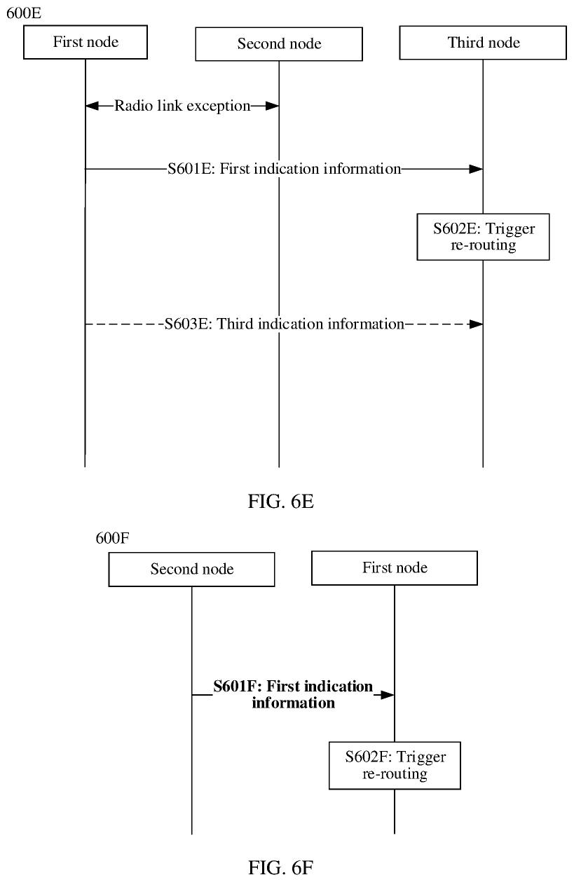

FIG. 6A shows a communication method 600A according to some embodiments.

As shown in FIG. 6A, a first node is a child node of a second node, the first node is a parent node of a third node, and a destination node is a donor node. Alternatively, as shown in FIG. 6A, a first node is a parent node of a second node, the first node is a child node of a third node, and a destination node is an access node (which further is referred to as a node accessed by a terminal device) of the terminal device. In FIG. 6A, the second node is located between the first node and a master base station/a master donor node of the first node, or between the first node and a secondary donor node of the first node; the second node is a master base station/a master donor node of the first node; or the second node is a secondary donor node of the first node. The master base station/the master donor node or the secondary donor node is understood with reference to the embodiment corresponding to FIG. 5.

At least one relay node is included between the second node and the destination node, or the second node is directly connected to the destination node. The communication method 600A includes the following steps.

S601A: The first node sends first indication information to the third node.

The first indication information indicates a radio link exception. For example, the first indication information indicates a radio link failure, or the first indication information indicates that a link recovery attempt is being made.

For example, the first node sends the first indication information to the third node in response to determining that the RLF occurs on a radio link between the first node and the second node. In this case, the first indication information indicates the radio link failure.

For example, the first node sends the first indication information to the third node in response to determining that the RLF occurs on a radio link between the first node and the second node, and the radio link recovery attempt is being made. In this case, the first indication information indicates that the link recovery attempt is being made.

For example, the first node sends the first indication information to the third node in response to determining that the RLF occurs on a radio link between the first node and the second node, and there is no other available path between the first node and the destination node. In this case, the first indication information indicates the radio link failure.

For example, the first node sends the first indication information to the third node in response to determining that the RLF occurs on a radio link between the first node and the second node, the radio link recovery attempt is being made, and there is no other available path between the first node and the destination node. In this case, the first indication information indicates that the link recovery attempt is being made.

The first indication information is carried in a backhaul adaptation protocol layer (BAP) control protocol data unit (control PDU) for sending.

S602A: After receiving the first indication information, the third node triggers re-routing.

For example, after receiving the first indication information, the third node re-routes a data packet to be sent to the destination node. Re-routing the data packet to be sent to the destination node means routing data to the destination node through another path. The other path further is referred to as a backup path, namely, a path different from an original path on which the third node routes data to the destination node via the first node before the RLF occurs.

For example, in response to the first node sending the first indication information to the third node in response to the RLF occurring on the radio link between the first node and the second node, or in response to the RLF occurring on the radio link between the first node and the second node, and the radio link recovery attempt is being made, through the foregoing operations S601A and S602A, the third node triggers a re-routing function of the data packet after receiving the first indication information, re-route the data packet to be sent to the destination node, and route the data packet to the destination node through another available path.

For example, in response to the first node sending the first indication information to the third node in response to the RLF occurring on the radio link between the first node and the second node, and there is no other available path between the first node and the destination node, or in response to the RLF occurring on the radio link between the first node and the second node, the radio link recovery attempt is being made, and there is no other available path between the first node and the destination node, through the foregoing operations S601A and S602A, the third node triggers a re-routing operation of the data packet after receiving the first indication information, and a re-routing function of the first node is fully utilized, to improve data relay stability and reduce overheads of air interface signaling. For example, there are a plurality of paths between the first node and the destination node. In response to the RLF occurring on one of the paths, the first node triggers the re-routing function, and route data to the destination node through another path. In this case, the first indication information is unable to need to be sent to the third node. Otherwise, unnecessary re-routing is performed by the third node, causing a waste of resources, and also causing transmission of a large amount of first indication information over an air interface.

Optionally, some embodiments, further include the following operation.

S603A: The first node sends second indication information to the third node.

The second indication information indicates that a path that passes through the first node to the destination node is unavailable.

For example, the second indication information includes a BAP address of the destination node. Specifically, for uplink transmission, the BAP address of the destination node is a BAP address of a donor-DU. For downlink transmission, the BAP address of the destination node is a BAP address of an access IAB node. In this case, that the second indication information indicates that a path that passes through the first node to the destination node is unavailable means that each path that passes through the first node to the destination node are unavailable.

For example, the second indication information includes a path identity (Path ID) corresponding to the path that passes through the first node to the destination node, or a path identity corresponding to a path from the first node to the destination node. In this case, that the second indication information indicates that a path that passes through the first node to the destination node is unavailable means that a path whose corresponding path ID is equal to the path ID included in the second indication information is unavailable in each path that passes through the first node to the destination node.

For example, the second indication information includes a routing identity (routing ID) corresponding to the path that passes through the first node to the destination node, or a routing identity corresponding to a path from the first node to the destination node. The routing identity includes the BAP address of the destination node and the path ID. Further, in response to there being a plurality of paths between the first node and the destination node, in response to the RLF occurring on one or more of the paths, the second indication information includes one or more routing identities. In this case, that the second indication information indicates that a path that passes through the first node to the destination node is unavailable means that a path whose corresponding routing ID is equal to the routing ID included in the second indication information is unavailable in each path that passes through the first node to the destination node. Alternatively, in this case, that the second indication information indicates that a path that passes through the first node to the destination node is unavailable means that each path that passes through the first node to the destination node are unavailable.

Correspondingly, the third node receives the second indication information.

For example, in response to the second indication information including the BAP address of the destination node, the third node determines, based on the second indication information, to route data to the destination node through another path. The other path does not include the first node.

For example, in response to the second indication information including the routing identity corresponding to the path that passes through the first node to the destination node (or the routing identity corresponding to the path from the first node to the destination node), the third node determines, based on the second indication information, to route data to the destination node through another path. A routing ID of the another path is not equal to the routing ID included in the second indication information. Alternatively, the other path does not include the first node.

The third node determines, based on the second indication information, to re-route the data packet to be sent to the destination node. In other words, the third node determines not to re-route a data packet to be sent to another destination node, and the data packet still is routed via the first node.

For example, in response to the second indication information including the path identity corresponding to the path that passes through the first node to the destination node (or the path identity corresponding to the path from the first node to the destination node), the donor node determines, based on the second indication information, to route data to the destination node through another path. A path identity of the other path is not equal to the path ID included in the second indication information.

The first indication information and the second indication information is carried in a same message, for example, carried in a same BAP control PDU, and sent to the third node. The first indication information and the second indication information is same indication information. In other words, the indication information has both a function of the first indication information and a function of the second indication information.

Operation S603A is an optional operation. The first node is unable to send the second indication information to the third node. For example, after receiving the first indication information, the third node determines to route data to the destination node through another path. The other path does not include the first node.

Through the foregoing operation S603A, the third node obtains more accurate information about the RLF, to implement more efficient and accurate re-routing. For example, the third node is unable to route data to the destination node via the first node, but also route other data to another destination node via the first node. Further, there is a plurality of paths between the first node and the destination node. In these cases, the third node performs more efficient and accurate re-routing based on the first indication information and the second indication information.

Optionally, some embodiments further include the following operation.

S604A: The first node sends third indication information to the third node.

The third indication information indicates that radio link recovery succeeds. The first node sends the third indication information to the third node in response to successfully recovering a link between the first node and a parent node, for example, in response to successfully recovering a link between the first node and the second node, or accessing a new parent node through an RRC re-establishment procedure.

Correspondingly, the third node receives the third indication information.

In a possible implementation, after receiving the third indication information, the third node disables the re-routing function, stops routing data to the destination node through another path (a backup path), and continues to route the data to the destination node through a source path (namely, an original primary path). For example, the third node continues to route the data to the first node, and the first node further routes the data to the destination node.

In another possible implementation, after receiving the third indication information, the third node does not disable the re-routing function, but continues to route data to the destination node through another path (a backup path) until an IAB donor configures a new routing configuration.

Through the foregoing operation S604A, the third node stops re-routing (or disable the re-routing function) in time, to reduce processing complexity of an upstream node or a downstream node of the third node.

In some embodiments, in response to the first node being a child node of the third node and is a parent node of the second node, the first indication information indicates the radio link failure. In response to the first node being a parent node of the third node and is a child node of the second node, the first indication information indicates the radio link failure, or the first indication information indicates that the link recovery attempt is being made.

In some embodiments, the first node, the second node, or the third node is an IAB node, the donor node is an IAB donor, and the access node of the terminal device is an access IAB node.

FIG. 6B shows a communication method 600B according to some embodiments. As shown in FIG. 6B, a second node is an upstream node of a first node (where for example, the second node is a parent node of the first node), and a donor node is a donor node connected to the first node and the second node. At least one relay node is included between the second node and the donor node, or the second node is directly connected to the donor node (where in some embodiments the donor node is a parent node of the second node). Some embodiments are applied to a scenario in which the first node sends an uplink data packet to a destination node via the second node. The destination node is the donor node. The communication method 600B includes the following steps.

S601B: The second node sends first information to the donor node.

(1) In a possible implementation, the first information includes a first threshold.

For example, the first information indicates to trigger uplink re-routing in response to a quantity of transmission/retransmission times of a data packet of the first node reaching/exceeding the first threshold. The data packet of the first node is any data packet at a BAP layer, an RLC layer, a MAC layer, or a PHY layer.

Specifically, the first information indicates to trigger uplink re-routing in response to a quantity of transmission/retransmission times of a BAP layer data packet (for example, a BAP PDU) of the first node being greater than or equal to the first threshold. Alternatively, the first information indicates to trigger uplink re-routing in response to a quantity of transmission/retransmission times of an RLC layer data packet (for example, an RLC PDU) of the first node being greater than or equal to the first threshold. The first threshold is less than a maximum retransmission threshold of the RLC layer, and the maximum retransmission threshold of the RLC layer is used by the first node to determine whether an RLF occurs on a link between the first node and the second node. The maximum retransmission threshold of the RLC layer is sent by the donor node to the first node by using an RRC message. Alternatively, the first information indicates to trigger uplink re-routing in response to a quantity of transmission/retransmission times of a MAC layer data packet (for example, a MAC PDU, which further is referred to as a transport block (TB)) of the first node being greater than or equal to the first threshold. Alternatively, the first information indicates to trigger uplink re-routing in response to a quantity of transmission/retransmission times of a PHY layer data packet (for example, a code block group (CBG)) of the first node being greater than or equal to the first threshold.

(2) In another possible implementation, the first information includes a configuration of a first timer, and the configuration of the first timer includes first timer duration.

For example, the first information indicates to trigger uplink re-routing in response to the first timer expiring and a data packet of the first node has not been successfully sent. The data packet of the first node is any data packet at a BAP layer, an RLC layer, a MAC layer, or a PHY layer.

Specifically, the first information indicates to trigger uplink re-routing in response to the first timer expiring (timing duration of the first timer reaches/exceeds the configured first timer duration) and a BAP layer data packet of the first node has not been successfully sent. Alternatively, the first information indicates to trigger uplink re-routing in response to the first timer expiring and an RLC layer data packet of the first node has not been successfully sent. The first timer duration needs to meet the following condition: Before the first timer expires, a quantity of transmission/retransmission times of the RLC layer data packet of the first node is less than a maximum retransmission threshold of the RLC layer. Alternatively, the first information indicates to trigger uplink re-routing in response to the first timer expiring and a MAC layer data packet of the first node has not been successfully sent. Alternatively, the first information indicates to trigger uplink re-routing in response to the first timer expiring and a PHY layer data packet of the first node has not been successfully sent.

In some embodiments, the first node or the second node is an IAB node (where for example, the first node is an access IAB node, and the second node is an intermediate IAB node), and the donor node is an IAB donor. For example, the second node sends the first information to a CU of the IAB donor by using an RRC message or an F1 AP message.

S602B: The donor node sends the first information to the first node.

For example, S602B is that the CU of the IAB donor sends the first information to an MT of the first node by using the RRC message, or is that the CU of the IAB donor sends the first information to a DU of the first node by using the F1AP message.

S601B is an optional step. For example, the first information is generated by the donor node and then sent to the first node. For another example, the second node is optional. The first node is directly connected to the donor node (where in other words, the donor node is a parent node of the first node). After generating the first information, the donor node directly sends the first information to the first node.

S601B and S602B are optional steps. In a possible implementation, the first information is unable to need to be forwarded by the donor node. For example, the second node includes the first information in a BAP control PDU or a media access control control element (MAC CE), and send the BAP control PDU or the media access control control element to the first node through a wireless backhaul link between the first node and the second node. In another possible implementation, the first information is generated by the first node. For example, the first node generates the first information according to a protocol specification, the first information is pre-configured in the first node, or the first node generates the first information based on a parameter such as quality of a channel between the first node and the second node.

S603B: The first node determines, based on the first information, whether to trigger uplink re-routing.

(1) in response to the first information including the first threshold, the first node triggers uplink re-routing in response to determining that the quantity of transmission/retransmission times of the BAP layer/RLC layer/MAC layer/PHY layer data packet is greater than or equal to the first threshold.

For example, the first node triggers uplink re-routing in response to detecting that the quantity of transmission/retransmission times of the BAP layer data packet is greater than or equal to the first threshold. Alternatively, the first node triggers uplink re-routing in response to detecting that the quantity of transmission/retransmission times of the RLC layer data packet is greater than or equal to the first threshold. Alternatively, the first node triggers uplink re-routing in response to detecting that the quantity of transmission/retransmission times of the MAC layer data packet is greater than or equal to the first threshold. Alternatively, the first node triggers uplink re-routing in response to detecting that the quantity of transmission/retransmission times of the uplink PHY layer data packet is greater than or equal to the first threshold.

(2) in response to the first information including the configuration of the first timer, the first node triggers uplink re-routing in response to determining that the first timer expires and the BAP layer/RLC layer/MAC layer/PHY layer data packet of the first node has not been successfully sent.

For example, the first node starts the timer in response to the BAP layer/RLC layer/MAC layer/PHY layer data packet being transmitted for the first time, that is, the first timer starts timing.

For example, uplink re-routing is triggered in response to the first timer expiring and the BAP layer data packet of the first node has not been successfully sent. Alternatively, uplink re-routing is triggered in response to the first timer expiring and the RLC layer data packet of the first node has not been successfully sent. Alternatively, uplink re-routing is triggered in response to the first timer expiring and the MAC layer data packet of the first node has not been successfully sent. Alternatively, uplink re-routing is triggered in response to the first timer expiring and the PHY layer data packet of the first node has not been successfully sent.

In the foregoing (1) and (2), the quantity of transmission/retransmission times of the BAP layer/RLC layer/MAC layer/PHY layer data packet is counted based on a granularity of a next-hop node or counted based on a next-hop link. The quantity of transmission/retransmission times of the BAP layer/RLC layer/MAC layer/PHY layer data packet is a total quantity of times that the first node transmits or retransmits the BAP layer/RLC layer/MAC layer/PHY layer data packet to the parent node (the second node or the donor node), or a total quantity of times that the first node transmits or retransmits the BAP layer/RLC layer/MAC layer/PHY layer data packet on a link between the first node and the parent node (the second node or the donor node).

For example, triggering uplink re-routing is understood as: The first node routes a data packet to the donor node through another path (namely, a backup path, where the backup path is unable to include the second node) or via another node (where the other node is not the second node). In response to the parent node of the first node being the second node, the data packet is no longer routed to the donor node via the second node. In response to the parent node of the first node being the donor node, the data packet is no longer directly routed to the donor node.

S604B: The first node stops uplink re-routing.

For example, after the first node triggers uplink re-routing, and before the first node determines that the RLF occurs between the first node and the second node/the donor node, in response to the data packet being successfully transmitted through a source path, the first node stops uplink re-routing.

Optionally, after the first node triggers uplink re-routing, and before the first node determines that the RLF occurs between the first node and the second node/the donor node, in response to the first node determining, through measurement, that quality of the link between the first node and the second node/the donor node is greater than a preset value, the first node stops uplink re-routing.

Optionally, after triggering uplink re-routing, the first node starts a timer. In response to the timer expiring, and the first node has not determined that the RLF occurs between the first node and the second node/the donor node, the first node stops uplink re-routing.

For example, stopping uplink re-routing is understood as: The first node stops routing data to the donor node through another path (namely, a backup path, where the backup path is unable to include the second node) or via another node (where the other node is not the second node), and continues to route the data to the donor node through a source path (namely, an original primary path, where the primary path includes the second node) or via the second node. In response to the parent node of the first node being the second node, the data packet continues to be routed to the donor node via the second node. In response to the parent node of the first node being the donor node, the data packet continues to be directly routed to the donor node.

S604B is an optional step. For example, the first node is unable to stop uplink re-routing until the donor node re-configures a new uplink route configuration for the first node.

According to some embodiments, the first node performs more efficient and accurate re-routing. In some embodiments, the first node flexibly triggers re-routing under the configuration of the donor node. In some embodiments, re-routing of the first node is triggered in advance before the link RLF occurs, to reduce possible data transmission interruptions and improve data transmission stability.

FIG. 6C shows a communication method 600C according to some embodiments. As shown in FIG. 6C, a first node is a parent node of a second node. The first node is directly or indirectly connected to a donor node, or the first node is the donor node. Some embodiments are applied to a scenario in which the first node sends a downlink data packet to a destination node via the second node. The destination node is an access node of a terminal device. At least one relay node is included between the second node and the destination node, the second node is a parent node of the destination node, or the second node is the destination node (where in this case, some embodiments are applied to a scenario in which the first node sends the downlink data packet to the second node). The communication method 600C includes the following steps.

S601C: The donor node sends second information to the first node.

(1) In a possible implementation, the second information includes a second threshold.

For example, the second information indicates to trigger downlink re-routing in response to a quantity of transmission/retransmission times of a data packet of the first node reaching/exceeding the second threshold. The data packet of the first node is any data packet at a BAP layer, an RLC layer, a MAC layer, or a PHY layer.

Specifically, the second information indicates to trigger downlink re-routing in response to a quantity of transmission/retransmission times of a BAP layer data packet of the first node being greater than or equal to the second threshold. Alternatively, the second information indicates to trigger downlink re-routing in response to a quantity of transmission/retransmission times of an RLC layer data packet of the first node being greater than or equal to the second threshold. The second threshold is less than a maximum retransmission threshold of the RLC layer, and the maximum retransmission threshold of the RLC layer is used by the first node to determine whether a radio link failure occurs on a link between the first node and the second node. The maximum retransmission threshold of the RLC layer is sent by the donor node to the first node by using an RRC message. Alternatively, the second information indicates to trigger downlink re-routing in response to a quantity of transmission/retransmission times of a MAC layer data packet of the first node being greater than or equal to the second threshold. Alternatively, the second information indicates to trigger downlink re-routing in response to a quantity of transmission/retransmission times of a PHY layer data packet of the first node being greater than or equal to the second threshold.

(2) In another possible implementation, the second information includes a configuration of a second timer, and the configuration of the second timer includes second timer duration.

For example, the second information indicates to trigger downlink re-routing in response to the second timer expires and a data packet of the first node not being successfully sent. The data packet of the first node is any data packet at a BAP layer, an RLC layer, a MAC layer, or a PHY layer.

Specifically, the second information indicates to trigger downlink re-routing in response to the second timer expiring (timing duration of the second timer reaches/exceeds the configured second timer duration) and a BAP layer data packet of the first node has not been successfully sent. Alternatively, the second information indicates to trigger downlink re-routing in response to the second timer expiring and an RLC layer data packet of the first node has not been successfully sent. The second timer duration needs to meet the following condition: Before the second timer expires, a quantity of transmission/retransmission times of the RLC layer data packet of the first node is less than a maximum retransmission threshold of the RLC layer. Alternatively, the second information indicates to trigger downlink re-routing in response to the second timer expiring and a MAC layer data packet of the first node has not been successfully sent. Alternatively, the second information indicates to trigger downlink re-routing in response to the second timer expiring and a PHY layer data packet of the first node has not been successfully sent.

In some embodiments, the first node or the second node is an IAB node (where for example, the first node is an intermediate IAB node, and the second node is an access IAB node), and the donor node is an IAB donor. For example, S601C is that a CU of the IAB donor sends the second information to an MT of the first node by using an RRC message. Alternatively, a CU of the IAB donor sends the second information to a DU of the first node by using an F1AP message.

S601C is an optional step. For example, the second information is generated by the first node. For example, the first node generates the second information according to a protocol specification, the second information is pre-configured in the first node, or the first node generates the second information based on quality of a channel between the first node and the second node. For another example, the first node is the donor node, and the first node includes a DU of the donor node and a CU of the donor node. The second information is sent by the CU of the donor node to the DU of the donor node, or generated by the DU of the donor node.

S602C: The first node determines, based on the second information, whether to trigger downlink re-routing.

(1) in response to the second information including the second threshold, the first node triggers downlink re-routing in response to determining that the quantity of transmission/retransmission times of the BAP layer/RLC layer/MAC layer/PHY layer data packet is greater than or equal to the second threshold.

For example, the first node triggers downlink re-routing in response to detecting that the quantity of transmission/retransmission times of the BAP layer data packet is greater than or equal to the second threshold. Alternatively, the first node triggers downlink re-routing in response to detecting that the quantity of transmission/retransmission times of the RLC layer data packet is greater than or equal to the second threshold. Alternatively, the first node triggers downlink re-routing in response to detecting that the quantity of transmission/retransmission times of the MAC layer data packet is greater than or equal to the second threshold. Alternatively, the first node triggers downlink re-routing in response to detecting that the quantity of transmission/retransmission times of the downlink PHY layer data packet is greater than or equal to the second threshold.

(2) in response to the second information including the configuration of the second timer, the first node triggers downlink re-routing in response to determining that the second timer expires and the BAP layer/RLC layer/MAC layer/PHY layer data packet has not been successfully sent.

For example, the first node starts the timer in response to the BAP layer/RLC layer/MAC layer/PHY layer data packet being transmitted for the first time, that is, the second timer starts timing.

For example, downlink re-routing is triggered in response to the second timer expiring and the BAP layer data packet of the first node has not been successfully sent. Alternatively, downlink re-routing is triggered in response to the second timer expiring and the RLC layer data packet of the first node has not been successfully sent. Alternatively, downlink re-routing is triggered in response to the second timer expiring and the MAC layer data packet of the first node has not been successfully sent. Alternatively, downlink re-routing is triggered in response to the second timer expiring and the PHY layer data packet of the first node has not been successfully sent.

In the foregoing (1) and (2), the quantity of transmission/retransmission times of the BAP layer/RLC layer/MAC layer/PHY layer data packet is counted based on a granularity of a next-hop node or counted based on a next-hop link. The quantity of transmission/retransmission times of the BAP layer/RLC layer/MAC layer/PHY layer data packet is a total quantity of times that the first node transmits or retransmits the BAP layer/RLC layer/MAC layer/PHY layer data packet to the second node, or a total quantity of times that the first node transmits or retransmits the BAP layer/RLC layer/MAC layer/PHY layer data packet on the link between the first node and the second node.

For example, triggering downlink re-routing is understood as: The first node routes a data packet to the destination node through another path (namely, a backup path, where the backup path is unable to include the second node) or via another node (where the other node is not the second node).

S603C: The first node stops downlink re-routing.

Optionally, after the first node triggers downlink re-routing, and before the first node determines that the RLF occurs between the first node and the second node, in response to the data packet being successfully transmitted through a source path, the first node stops downlink re-routing.

Optionally, after the first node triggers downlink re-routing, and before the first node determines that the RLF occurs between the first node and the second node, in response to the first node determining, through measurement or feedback of the second node (for example, a channel quality information (channel quality information, CQI) feedback of the PHY layer), that quality of the link between the first node and the second node is greater than a preset value, the first node stops downlink re-routing.

Optionally, after triggering downlink re-routing, the first node starts a timer. In response to the timer expiring, and the first node has not determined that the RLF occurs between the first node and the second node, the first node stops downlink re-routing.

For example, stopping downlink re-routing is understood as: The first node stops routing data to the destination node through another path (namely, a backup path, where the backup path is unable to include the second node) or via another node (where the other node is not the second node), and continues to route the data to the destination node through a source path (namely, an original primary path, where the primary path includes the second node) or via the second node.

B603C is an optional step. For example, the first node is unable to stop downlink re-routing until the donor node re-configures a new downlink route configuration for the first node.

In some embodiments, in the method 600B, in response to the first node determining to trigger uplink re-routing, the first node stops routing the data packet to the donor node through the source path. In the method 600C, in response to the first node determining to trigger downlink re-routing, the first node stops routing the data packet to the destination node through the source path. That the first node stops routing the data packet to the destination node through the source path may specifically include at least one of the following: The BAP layer of the first node sends indication information to the RLC layer, where the indication information indicates the RLC layer to perform re-establishment; or the BAP layer of the first node sends indication information to the MAC layer, where the indication information indicates the MAC layer to perform reset (reset).

Certainly, in the method 600B, in response to the first node determining to trigger uplink re-routing, the first node alternatively is unable to stop routing the data packet to the destination node through the source path. In the method 600C, in response to the first node determining to trigger downlink re-routing, the first node alternatively is unable to stop routing the data packet to the destination node through the source path. For example, the first node supports a DC function, an MC function, or an NSA function. After the first node triggers uplink/downlink re-routing, and before the first node determines that the RLF occurs between the first node and the second node, the first node not routes data (for example, retransmitted data at the RLC layer or the MAC layer) through the backup path, but also routes data through the source path.

In some embodiments, the first information in the method 600B and the second information in the method 600C is the same as third information. The first threshold and the second threshold is the same as a third threshold. In this case, the third information indicates to trigger re-routing in response to the quantity of transmission/retransmission times of the data packet of the first node reaching/exceeding the third threshold. The configuration of the first timer and the configuration of the second timer is the same as a configuration of a third timer. In this case, the third information indicates to trigger re-routing in response to the third timer expiring and the data packet of the first node has not been successfully sent. In other words, the first node determines, based on the third information, whether to trigger uplink re-routing, or determines, based on the third information, whether to trigger downlink re-routing. In this way, overheads of air interface signaling is reduced.

FIG. 6D shows a communication method 600D according to some embodiments.

As shown in FIG. 6D, a first node is a child node of a second node, the first node is a parent node of a third node, and a destination node is a donor node. Alternatively, as shown in FIG. 6D, a first node is a parent node of a second node, the first node is a child node of a third node, and a destination node is an access node (which further is referred to as a node accessed by a terminal device) of the terminal device.

At least one relay node is included between the second node and the destination node, or the second node is directly connected to the destination node. The communication method 600D includes the following steps.

S601D: The first node sends first indication information to the third node.

The first indication information indicates a radio link exception. For example, the first indication information indicates a radio link failure, or the first indication information indicates that a link recovery attempt is being made.

For example, in response to determining that radio links between the first node and second nodes are unavailable (where for example, the RLF occurs on the radio links, congestion occurs on the radio links, the radio links are unavailable due to flow control, or backhaul RLC channels between the first node and the second nodes are unavailable) (or in response to the first node determining that radio links between the first node and child nodes or parent nodes are unavailable), the first node sends the first indication information to the third node. Specifically, in response to determining that the radio links between the first node and the second nodes are unavailable, a DU of the first node sends indication information to an MT of the first node, where the indication information indicates the MT of the first node to send the first indication information to the third node.

For example, in response to determining that the radio links between the first node and the second nodes are unavailable, and a radio link recovery attempt is being made (for example, in response to the second node being located between the first node and a master base station/a master donor node of the first node, or the second node is a master base station/a master donor node of the first node, in process of attempting master cell group (MCG) recovery; for another example, in response to the second node being located between the first node and a secondary donor node of the first node or the second node is a secondary donor node of the first node, in a process of attempting secondary cell group (SCG) recovery), the first node sends the first indication information to the third node. In this case, the first indication information indicates that the link recovery attempt is being made. Specifically, in response to determining that the radio links between the first node and the second nodes are unavailable, and the radio link recovery attempt is being made, the DU of the first node sends indication information to the MT of the first node, where the indication information indicates the MT of the first node to send the first indication information to the third node.

The first indication information is carried in a backhaul adaptation protocol (BAP) control protocol data unit (control PDU) or a media access control control element (MAC CE) for sending.

S602D: After receiving the first indication information, the third node triggers re-routing.

For example, after receiving the first indication information, the third node re-routes a data packet to be sent to the destination node. Re-routing the data packet to be sent to the destination node means routing data to the destination node through another path. The other path further is referred to as a backup path, namely, a path different from an original path on which the third node routes data to the destination node via the first node before the radio links between the first node and the second nodes are unavailable.

Through the foregoing operations S601D and S602D, the third node triggers a re-routing function of the data packet after receiving the first indication information, re-route the data packet to be sent to the destination node, and route the data packet to the destination node through another available path. This ensures stability, timeliness, and reliability of data transmission.

Optionally, some embodiments further include the following operation.

S603D: The first node sends second indication information to the third node.

In a possible implementation, the second indication information indicates that the first node is unavailable. For example, the second indication information includes an identifier of the first node, for example, a BAP address of the first node.

In another possible implementation, the second indication information indicates that channels between the first node and the second nodes are unavailable. For example, the second indication information includes an identifier of a second backhaul RLC channel, and there is a correspondence between the second backhaul RLC channel and a first backhaul RLC channel. The first backhaul RLC channel includes backhaul RLC channels between the first node and the second node, and the second backhaul RLC channel includes backhaul RLC channels between the first node and the third node.

There is many possibilities for the correspondence between the second backhaul RLC channel and the first backhaul RLC channel. This is not limited in this application. For example, a backhaul RLC channel in the second backhaul RLC channel corresponds to one or more backhaul RLC channels in the first backhaul RLC channel. A backhaul RLC channel in the first backhaul RLC channel further corresponds to one or more backhaul RLC channels in the second backhaul RLC channel. The first node maps data from the first backhaul RLC channel to the second backhaul RLC channel based on the correspondence between the second backhaul RLC channel and the first backhaul RLC channel, or the first node maps data from the second backhaul RLC channel to the first backhaul RLC channel based on the correspondence.

In this application, a correspondence between a radio link and a backhaul RLC channel is one-to-one, many-to-one, or one-to-many. This is not limited in this application.

Correspondingly, the third node receives the second indication information. In response to the second indication information, the third node determines to route data (which is understood as data that originally needs to be routed via the first node) to the destination node through another path. The other path does not include the first node.

The first indication information and the second indication information is carried in a same message, for example, carried in a same BAP control PDU or MAC CE, and sent to the third node. The first indication information and the second indication information is same indication information. In other words, the indication information has both a function of the first indication information and a function of the second indication information.

Operation S603D is an optional operation. The first node is unable to send the second indication information to the third node. For example, after receiving the first indication information, the third node determines to route data to the destination node through another path. The other path does not include the first node.

Through the foregoing operation S603D, the third node obtains more accurate information about the RLF, to implement more efficient and accurate re-routing. For example, the third node is unable to route data to the destination node via the first node, but also route other data to another destination node via the first node. Further, there is a plurality of paths between the first node and the destination node. In these cases, the third node performs more efficient and accurate re-routing based on the first indication information and the second indication information.

Optionally, some embodiments further include the following operation.

S604D: The first node sends third indication information to the third node.

The third indication information indicates that radio link recovery succeeds. The first node sends the third indication information to the third node in response to successfully recovering a link between the first node and the second node, for example, in response to successfully recovering a link between the first node and a second node, successfully recovering a backhaul RLC channel between the first node and a second node, or accessing a new second node by using an RRC re-establishment procedure.

Correspondingly, the third node receives the third indication information.

In a possible implementation, after receiving the third indication information, the third node disables the re-routing function, stops routing data to the destination node through another path (a backup path), and continues to route the data to the destination node through a source path (namely, an original primary path). For example, the third node continues to route the data to the first node, and the first node further routes the data to the destination node.

In another possible implementation, after receiving the third indication information, the third node does not disable the re-routing function, but continues to route data to the destination node through another path (a backup path) until the donor node configures a new routing configuration.

Through the foregoing operation S604D, the third node stops re-routing (or disable the re-routing function) in time, to reduce processing complexity of an upstream node or a downstream node of the third node.

In some embodiments, in response to the first node being a child node of the third node and is a parent node of the second node, the first indication information indicates the radio link failure. In response to the first node being a parent node of the third node and is a child node of the second node, the first indication information indicates the radio link failure, or the first indication information indicates that the link recovery attempt is being made.

In some embodiments, the first node, the second node, or the third node is an IAB node, the donor node is an IAB donor, and the access node of the terminal device is an access IAB node.

FIG. 6E shows a communication method 600E according to some embodiments.

As shown in FIG. 6E, a first node is a child node of a second node, the first node is a parent node of a third node, and a destination node is a donor node. Alternatively, as shown in FIG. 6E, a first node is a parent node of a second node, the first node is a child node of a third node, and a destination node is an access node (which further is referred to as a node accessed by a terminal device) of the terminal device. In FIG. 6E, the second node is located between the first node and a master base station/a master donor node of the first node, or between the first node and a secondary donor node of the first node; the second node is a master base station/a master donor node of the first node; or the second node is a secondary donor node of the first node. The master base station/the master donor node or the secondary donor node is understood with reference to the embodiment corresponding to FIG. 5.

At least one relay node is included between the second node and the destination node, or the second node is directly connected to the destination node. The communication method 600E includes the following steps.

S601E: The first node sends first indication information to the third node.

The first indication information indicates a radio link exception, for example, indicates a radio link failure, indicate that a backhaul RLC channel is unavailable (where for example, the RLF occurs on the backhaul RLC channel, congestion occurs on the backhaul RLC channel, or the backhaul RLC channel is unavailable due to flow control), an attempt is being made to recover the backhaul RLC channel, a path identified by a first routing ID is unavailable, or a path recovery attempt is being made.

For example, the first node sends the first indication information to the third node in response to determining that a first backhaul RLC channel between the first node and the second node is unavailable (for example, the RLF occurs on the first backhaul RLC channel, congestion occurs on the first backhaul RLC channel, or the first backhaul RLC channel is unavailable due to flow control). Specifically, in response to determining that the first backhaul RLC channel is unavailable, a DU of the first node sends indication information to an MT of the first node, where the indication information indicates the MT of the first node to send the first indication information to the third node.

For example, in response to determining that the first backhaul RLC channel between the first node and the second node is unavailable, and the attempt is being made to recover the backhaul RLC channel (for example, in response to the second node being located between the first node and the master base station/the master donor node of the first node, or the second node is the master base station/the master donor node of the first node, in process of attempting master cell group (MCG) recovery; for another example, in response to the second node being located between the first node and the secondary donor node of the first node, or the second node is the secondary donor node of the first node, in a process of attempting secondary cell group (SCG) recovery), the first node sends the first indication information to the third node. Specifically, in response to determining that the first backhaul RLC channel is unavailable, and the attempt is being made to recover the backhaul RLC channel, the DU of the first node sends indication information to the MT of the first node, where the indication information indicates the MT of the first node to send the first indication information to the third node.

Optionally, the first indication information includes an identifier of a second backhaul RLC channel. The second backhaul RLC channel is a backhaul RLC channel between the first node and the third node. There is a correspondence between the second backhaul RLC channel and the unavailable first backhaul RLC channel. The first backhaul RLC channel is an unavailable backhaul RLC channel between the first node and the second node. There is many possibilities for the correspondence between the second backhaul RLC channel and the unavailable first backhaul RLC channel. This is not limited in the embodiments. For example, the second backhaul RLC channel corresponds to one or more unavailable first backhaul RLC channels, and the unavailable first backhaul RLC channel further corresponds to one or more second backhaul RLC channels. The first node maps data from the first backhaul RLC channel to the second backhaul RLC channel based on the correspondence between the second backhaul RLC channel and the first backhaul RLC channel, or the first node maps data from the second backhaul RLC channel to the first backhaul RLC channel based on the correspondence.

For example, the first node sends the first indication information to the third node in response to determining that the path identified by the first routing ID between the first node and the second node is unavailable. Specifically, in response to determining that the path identified by the first routing ID is unavailable, the DU of the first node sends indication information to the MT of the first node, where the indication information indicates the MT of the first node to send the first indication information to the third node.

For example, in response to determining that the path identified by the first routing ID between the first node and the second node is unavailable, and the path recovery attempt is being made (for example, in response to the second node being located between the first node and the master base station/the master donor node of the first node, or the second node is the master base station/the master donor node of the first node, in process of attempting master cell group (MCG) recovery; for another example, in response to the second node being located between the first node and the secondary donor node of the first node, or the second node is the secondary donor node of the first node, in a process of attempting secondary cell group (SCG) recovery), the first node sends the first indication information to the third node. Specifically, in response to determining that the path identified by the first routing ID is unavailable, and the path recovery attempt is being made, the DU of the first node sends indication information to the MT of the first node, where the indication information indicates the MT of the first node to send the first indication information to the third node.

Optionally, the first indication information includes the first routing ID.

The first indication information is carried in a BAP control PDU or a MAC CE for sending.

S602E: After receiving the first indication information, the third node triggers re-routing.

For example, after receiving the first indication information, the third node re-routes a data packet to be sent to the destination node. Re-routing the data packet to be sent to the destination node means routing data to the destination node through another path. The other path further is referred to as a backup path, namely, a path different from an original path on which the third node routes data to the destination node via the first node before the first backhaul RLC channel is unavailable or the path identified by the first routing ID is unavailable.

For example, in response to the first node sending the first indication information to the third node in response to the first backhaul RLC channel between the first node and the second node being unavailable, or in response to the first backhaul RLC channel between the first node and the second node being unavailable, and the attempt is being made to recover the backhaul RLC channel, through the foregoing operations S601E and S602E, the third node triggers a re-routing function of the data packet after receiving the first indication information, re-route the data packet to be sent to the destination node, and route the data packet to the destination node through another available path.

For example, in response to the first node sending the first indication information to the third node in response to the path identified by the first routing ID between the first node and the second node being unavailable, or in response to the path identified by the first routing ID being unavailable, and the path recovery attempt is being made, through the foregoing operations S601E and S602E, the third node triggers a re-routing function of the data packet after receiving the first indication information, re-route the data packet to be sent to the destination node, and route the data packet to the destination node through another available path.

For example, in response to the second indication information including the identifier of the second backhaul RLC channel, the third node determines, based on the second indication information, to route, to the destination node through another path, data that originally needs to be mapped to the second backhaul RLC channel (where in other words, before the first backhaul RLC channel becomes unavailable, the third node maps the data to the second backhaul RLC channel for transmission). The other path does not include the first node or does not pass through the second backhaul RLC channel.

For example, in response to the second indication information including the first routing ID, the third node determines, based on the second indication information, to route data to the destination node through another path (where for example, a routing ID carried in the data is equal to the first routing ID included in the second indication information). A routing ID of the other path is not equal to the first routing ID included in the second indication information.

Through the foregoing operations S601E and S602E, the third node obtains more accurate information about the link exception, to implement more efficient and accurate re-routing.

Optionally, some embodiments further include the following operation.

S603E: The first node sends third indication information to the third node.

The third indication information indicates that recovery of the backhaul RLC channel or path succeeds. The first node sends the third indication information to the third node in response to the first backhaul RLC channel or the path identified by the first routing ID between the first node and the second node being successfully recovered.

Correspondingly, the third node receives the third indication information.

In a possible implementation, after receiving the third indication information, the third node disables the re-routing function, stops routing data to the destination node through another path (a backup path), and continues to route the data to the destination node through the second backhaul RLC channel or the path identified by the first routing ID. For example, the third node continues to route the data to the first node, and the first node further routes the data to the destination node.

In another possible implementation, after receiving the third indication information, the third node does not disable the re-routing function, but continues to route, to the destination node through another path (a backup path), data that originally needs to be mapped to the second backhaul RLC channel or data that carries a routing ID equal to the first routing ID, until an IAB donor configures a new routing configuration.

Through the foregoing operation S603E, the third node stops re-routing (or disable the re-routing function) in time, to reduce processing complexity of an upstream node or a downstream node of the third node.

In some embodiments, the first node, the second node, or the third node is an IAB node, the donor node is an IAB donor, and the access node of the terminal device is an access IAB node.

FIG. 6F shows a communication method 600F according to some embodiments.

As shown in FIG. 6F, a first node is a child node of a second node; a first node is a parent node of a second node; or a first node is a donor node of a second node. The first node is located between the second node and a master base station/a master donor node of the second node, or between the second node and a secondary donor node of the second node; the first node is a master base station/a master donor node of the second node; or the first node is a secondary donor node of the second node. The master base station/the master donor node or the secondary donor node is understood with reference to the embodiment corresponding to FIG. 5.

S601F: The second node sends first indication information to the first node.

The first indication information indicates a radio link exception. For example, the first indication information indicates a radio link failure, or the first indication information indicates that a link recovery attempt is being made or a BAP PDU is unable to be routed.

In response to determining that a first BAP PDU is unable to be routed (for example, the first BAP PDU is congested in the first node, or the first BAP PDU has not been sent in the first node within preset duration), the second node sends the first indication information to the first node. Specifically, in response to determining that the first BAP PDU is unable to be routed, a DU of the second node sends indication information to an MT of the second node, where the indication information indicates the MT of the second node to send the first indication information to the first node.

Optionally, the first indication information includes a routing identity (routing ID) or a BAP address corresponding to the first BAP PDU. The routing identity (routing ID) or the BAP address corresponding to the first BAP PDU is a routing ID or a BAP address carried in a BAP header of the first BAP PDU.

S602F: The first node triggers re-routing in response to the first indication information.

For example, after receiving the first indication information, the first node re-routes a data packet to be sent to a destination node. Re-routing the data packet to be sent to the destination node means routing data to the destination node through another path. The other path further is referred to as a backup path, namely, a path different from an original path on which the first node routes data to the destination node via the second node before the first indication information is received.

For example, in response to the first indication information including the BAP address, the first node determines, based on the first indication information, to route the first BAP PDU to the destination node through another path. The BAP header of the first BAP PDU carries the routing ID or the BAP address. The other path does not include the second node.

For example, in response to the second indication information including the routing identity, the first node determines, based on the first indication information, to route the first BAP PDU to the destination node through another path. The BAP header of the first BAP PDU carries the routing ID or the BAP address. A routing ID of the other path is not equal to the routing ID included in the first indication information. Alternatively, the other path does not include the second node.

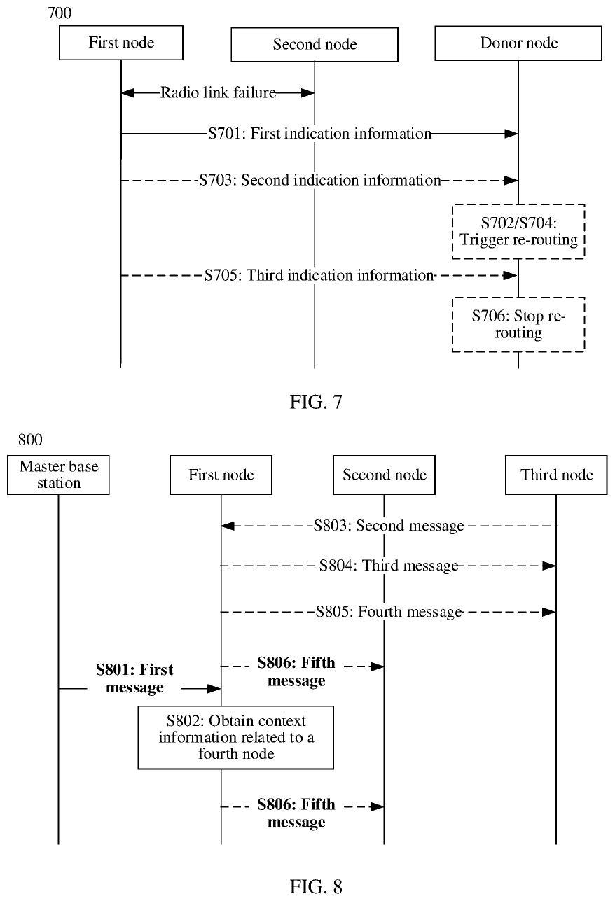

FIG. 7 shows a communication method 700 according to some embodiments. As shown in FIG. 7, a first node is a parent node of a second node, a donor node is a donor node connected to the first node, and a destination node is an access node of a terminal device. The communication method 700 includes the following steps.

S701: The first node sends first indication information to the donor node.

The first indication information indicates a radio link failure.

For example, the first node sends the first indication information to the donor node in response to determining that the RLF occurs on a radio link between the first node and the second node. In this case, the first indication information indicates the radio link failure.

For example, the first node sends the first indication information to the donor node in response to determining that the RLF occurs on a radio link between the first node and the second node, and there is no other available path between the first node and the destination node. In this case, the first indication information indicates the radio link failure.

In an implementation, the first indication information is carried in an F1 AP message, for example, a user equipment context release request (UE Context Release Request) message. Specifically, a cause field in the UE context release request message is set to a radio link failure indication (RLF indication).

In another implementation, the first indication information alternatively is carried in a BAP control PDU, and sent to the donor node in a hop-by-hop manner.

S702: The donor node receives the first indication information.

For example, after receiving the first indication information, the donor node re-routes a data packet to be sent to the destination node. Re-routing the data packet to be sent to the destination node means routing data to the destination node through another path. The other path further is referred to as a backup path.

For example, in response to the first node sending the first indication information to the donor node in response to the RLF occurring on the radio link between the first node and the second node, through the foregoing operations S701 and S702, the donor node triggers a re-routing function of the data packet after receiving the first indication information, re-route the data packet to be sent to the destination node, and route the data packet to the destination node through another available path.

For example, in response to the first node sending the first indication information to the donor node in response to the RLF occurring on the radio link between the first node and the second node, and there is no other available path between the first node and the destination node, through the foregoing operations S701 and S702, the donor node triggers a re-routing operation of the data packet after receiving the first indication information, and a re-routing function of the first node is fully utilized, to improve data relay stability and reduce overheads of air interface signaling. For example, there are a plurality of paths between the first node and the destination node. In response to the RLF occurring on one of the paths, the first node performs re-routing, and route data to the destination node through another path. In this case, the first indication information is unable to need to be sent to the donor node. Otherwise, unnecessary re-routing is performed by the donor node, causing a waste of resources, and also causing transmission of a large amount of first indication information over an air interface.

Optionally, some embodiments further include the following operation.

S703: The first node sends second indication information to the donor node.

The second indication information indicates that a path that passes through the first node to the destination node is unavailable.

For example, the second indication information includes a BAP address of the destination node. Specifically, the BAP address of the destination node is a BAP address of an access IAB node. In this case, that the second indication information indicates that a path that passes through the first node to the destination node is unavailable means that each path that passes through the first node to the destination node are unavailable.

For example, the second indication information includes a path identity (Path ID) corresponding to the path that passes through the first node to the destination node, or a path identity corresponding to a path from the first node to the destination node. In this case, that the second indication information indicates that a path that passes through the first node to the destination node is unavailable means that a path whose corresponding path ID is equal to the path ID included in the second indication information is unavailable in each path that passes through the first node to the destination node.

For example, the second indication information includes a routing ID corresponding to the path that passes through the first node to the destination node, or a routing identity corresponding to a path from the first node to the destination node. The routing identity includes the BAP address of the destination node and the path ID. Further, in response to there being a plurality of paths between the first node and the destination node, in response to the RLF occurring on one or more of the paths, the second indication information includes one or more routing IDs. In this case, that the second indication information indicates that a path that passes through the first node to the destination node is unavailable means that a path whose corresponding routing ID is equal to the routing ID included in the second indication information is unavailable in each path that passes through the first node to the destination node. Alternatively, in this case, that the second indication information indicates that a path that passes through the first node to the destination node is unavailable means that each path that passes through the first node to the destination node are unavailable.

For example, the second indication information includes an identifier of the second node. The identifier of the second node is a BAP address of the second node. The identifier of the second node alternatively is an identifier of the second node on an F1 interface between the second node and the donor node, for example, an F1 interface application protocol identity (F1AP ID). In this case, that the second indication information indicates that a path that passes through the first node to the destination node is unavailable means that a path that includes the direct radio link between the first node and the second node is unavailable in each path that passes through the first node to the destination node. Alternatively, in this case, that the second indication information indicates that a path that passes through the first node to the destination node is unavailable means that each path that passes through the first node to the destination node are unavailable.

S704: The donor node receives the second indication information.

For example, in response to the second indication information including the BAP address of the destination node, the donor node determines, based on the second indication information, to route data to the destination node through another path. The other path does not include the first node.

For example, in response to the second indication information including the routing ID corresponding to the path that passes through the first node to the destination node (or the routing identity corresponding to the path from the first node to the destination node), the donor node determines, based on the second indication information, to route data to the destination node through another path. A routing ID of the other path is not equal to the routing ID included in the second indication information.

The donor node determines, based on the second indication information, to re-route the data packet to be sent to the destination node. In other words, the donor node determines not to re-route a data packet to be sent to another destination node, and the data packet still is routed via the first node.

For example, in response to the second indication information including the path identity corresponding to the path that passes through the first node to the destination node (or the path identity corresponding to the path from the first node to the destination node), the donor node determines, based on the second indication information, to route data to the destination node through another path. A path identity of the other path is not equal to the path ID included in the second indication information.

For example, in response to the second indication information including the identifier of the second node, the donor node determines, based on the second indication information, to route data to the destination node through another path. A routing ID of the other path is not equal to a routing ID corresponding to a path that passes through the first node to the destination node and that includes the direct radio link between the first node and the second node. Alternatively, the other path does not include the first node.

The first indication information and the second indication information is carried in a same message and sent to the donor node, for example, carried in the same F1 AP message, for example, the UE context release request message, or is carried in the same BAP control PDU and sent to the donor node in a hop-by-hop manner.

Operations S703 and S704 are optional operations. The first node is unable to send the second indication information to the donor node. For example, after receiving the first indication information, the donor node determines to route data to the destination node through another path. The other path does not include the first node.

Through the foregoing operations S701 to S704, the donor node obtains more accurate information about the RLF, to implement more efficient and accurate re-routing. For example, the donor node is unable to route data to the destination node via the first node, but also route other data to another destination node via the first node. Further, there is a plurality of paths between the first node and the destination node. In these cases, the donor node performs more efficient and accurate re-routing based on the first indication information and the second indication information.

In some embodiments, the first node, the second node, or the third node is an IAB node, the donor node is an IAB donor, and the access node of the terminal device is an access IAB node.

FIG. 8 shows a communication method 800 according to some embodiments. As shown in FIG. 8, a first node is a parent node of a second node, a donor node is a donor node connected to the first node, and a destination node is an access node of a terminal device. The communication method 800 includes the following steps.

S801: A master base station sends a first message to the first node.

In response to the master base station being a master base station of the second node, the first message requests to add the first node as a secondary base station of the second node.

In response to the master base station being a master base station of a fourth node, the first message requests to add the first node as a secondary base station of the fourth node.

The master base station sends the first message to the first node after receiving a sixth message from a third node. The third node is a source secondary base station of the second node or the fourth node. The sixth message requests to use the first node as a target secondary base station of the second node or the fourth node. The sixth message includes an identifier of the first node. The identifier of the first node is a base station identifier (gNB ID) of the first node.

The master base station is an LTE master base station (MeNB). The secondary base station is an NR secondary base station (SgNB). Optionally, the master base station alternatively is an NR master base station, and the secondary base station is an NR secondary base station.

For example, in response to the first message requesting to add the first node as a secondary base station of the second node, the first message includes a physical cell identifier (PCI) of a cell that is of the third node and that is accessed by the second node and a cell radio network temporary identifier (C-RNTI) of the second node in a cell of the third node. The second node is a downstream node of the third node. For example, the second node is a child node of the third node, or is a child node of the child node of the third node. The second node is a wireless backhaul device or a terminal. The cell that is of the third node and that is accessed by the second node is a cell that is provided by the third node and that is used to serve the fourth node.

For example, in response to the first message requesting to add the first node as a secondary base station of the second node, the first message includes an identifier of the third node and an identifier of the second node on an interface between the third node and the first node. The identifier of the third node is a base station identifier (for example, a gNB ID) of the third node. The interface between the third node and the first node is an X2 interface, and the identifier of the second node on the interface between the third node and the first node is a user application protocol identity (UE X2AP ID) allocated by the third node to the second node on the X2 interface, a UE X2AP ID allocated by the first node to the second node on the X2 interface, or the UE X2AP ID allocated by the third node to the second node on the X2 interface and the UE X2AP ID allocated by the first node to the second node on the X2 interface. Alternatively, the interface between the third node and the first node is an Xn interface, and the identifier of the second node on the interface between the third node and the first node is a user application protocol identity (UE XnAP ID) allocated by the third node to the second node on the Xn interface, a UE XnAP ID allocated by the first node to the second node on the Xn interface, or the UE XnAP ID allocated by the third node to the second node on the Xn interface and the UE XnAP ID allocated by the first node to the second node on the Xn interface.

For example, in response to the first message requesting to add the first node as a secondary base station of the fourth node, the first message includes a physical cell identifier (PCI) of a cell that is of the second node and that is accessed by the fourth node and a cell radio network temporary identifier (C-RNTI) of the fourth node in the cell of the second node. The fourth node is a downstream node of the second node. For example, the fourth node is a child node of the second node, or is a child node of the child node of the second node. The fourth node is a wireless backhaul device or a terminal. The cell that is of the second node and that is accessed by the fourth node is a cell that is provided by the second node and that is used to serve the fourth node. For example, in response to the first message requesting to add the first node as a secondary base station of the fourth node, the first message includes an identifier of the third node and an identifier of the fourth node on an interface between the third node and the first node. The identifier of the third node is a base station identifier (for example, a gNB ID) of the third node. The interface between the third node and the first node is an X2 interface, and the identifier of the fourth node on the interface between the third node and the first node is a user application protocol identity (UE X2AP ID) allocated by the third node to the fourth node on the X2 interface, a UE X2AP ID allocated by the first node to the fourth node on the X2 interface, or the UE X2AP ID allocated by the third node to the fourth node on the X2 interface and the UE X2AP ID allocated by the first node to the fourth node on the X2 interface. Alternatively, the interface between the third node and the first node is an Xn interface, and the identifier of the fourth node on the interface between the third node and the first node is a user application protocol identity (UE XnAP ID) allocated by the third node to the fourth node on the Xn interface, a UE XnAP ID allocated by the first node to the fourth node on the Xn interface, or the UE XnAP ID allocated by the third node to the fourth node on the Xn interface and the UE XnAP ID allocated by the first node to the fourth node on the Xn interface.

The first message is a secondary base station addition request (for example, an SgNB addition request) message, or a secondary base station modification request (for example, an SgNB modification request) message. The second message is a secondary base station change request (for example, SgNB change desired).

S802: The first node receives the first message.

For example, after receiving the first message, the first node obtains context information of the second node. For example, the first node extracts the context information of the second node from an internal cache based on an identifier of the second node in the first message.

For example, after receiving the first message, the first node obtains context information of the fourth node. For example, the first node extracts the context information of the fourth node from an internal cache based on an identifier of the fourth node in the first message.

Optionally, the context information that is of the second node or the fourth node and that is cached on the first node is obtained from the third node in advance by using the following operation and cached on the first node:

S803: The first node receives a second message from the second node.

The second message requests to establish or re-establish a radio resource control (RRC) connection to the second node. The second message is an RRC re-establishment request message (for example, an RRC re-establishment request).

The second node sends the second message to the first node in response to an RLF occurring on a radio link between the second node and the third node.

It is noted that in this embodiment, a scenario in which the second node is directly connected to the first node is used as an example for description. This embodiment is also applicable to a scenario in which the second node is connected to the first node by using at least one other wireless backhaul device, in other words, the second node sends the second message to the first node by using at least one other wireless backhaul device.

S804: The first node sends a third message to the third node.

The third message requests to obtain context information related to the second node. The third message is a user equipment context obtaining request message (for example, a retrieve UE context request).

S805: The first node receives a fourth message from the third node.

The fourth message includes the context information related to the second node. The fourth message is a user equipment context obtaining response message (retrieve UE context response).

The context information related to the second node includes at least one of the following: the context information of the second node, topology information between the second node and a downstream node of the second node, context information of the downstream node of the second node, indication information indicating whether the second node is a wireless backhaul device, or indication information indicating whether the downstream node of the second node is a wireless backhaul device. The downstream node of the second node includes a child node of the second node, a child node of the child node, and the like, is a wireless backhaul device, or is a terminal. In this embodiment, the downstream node of the second node refers to the fourth node.

The context information of the downstream node of the second node includes the PCI and the C-RNTI, or the context information of the downstream node of the second node includes the identifier of the third node and an identifier of the downstream node on the interface between the third node and the first node.

In response to the second node being an IAB node, the context information of the second node includes a context of an MT of the IAB node and/or a context of a DU of the IAB node. The context of the MT of the IAB node includes configuration information of a backhaul radio link control channel (BH RLC CH). The context of the DU of the IAB node includes an identifier of the IAB-DU, a configuration of a cell of the IAB-DU, and the like.

Optionally, the topology information between the second node and the downstream node of the second node includes indication information indicating that the downstream node of the second node is a terminal device, and/or indication information indicating that the downstream node of the second node is a wireless backhaul device.

Through the foregoing operations S803 to S805, the first node obtains the context information of the fourth node, and the first node locally caches the context information of the fourth node, so that after receiving the first message sent by the master base station of the fourth node, the first node extracts the context information of the fourth node from the cache based on the identifier of the fourth node carried in the first message.

Optionally, some embodiments further include the following operation.

S806: The first node sends a fifth message to the second node.

For example, the fifth message is used to establish or re-establish the RRC connection to the second node. The fifth message is an RRC re-establishment message (for example, RRC re-establishment).

For example, the fifth message includes information used to update a cell served by the second node. The information used to update the cell served by the second node includes a cell global identifier (CGI) and/or a cell identifier of the cell in response to the second node being connected to the first node. The cell identity includes a base station identifier (for example, a gNB Id) and a cell local identifier (cellLocalId). The cell global identifier CGI includes a public land mobile network identifier (PLMNId), a base station identifier (for example, a gNB Id), and cellLocalId. Specifically, the first node allocates a new CGI and/or cell identity to the cell served by the second node, and sends the new CGI and/or cell identity to the second node by using the fifth message. A base station identifier (for example, a gNB ID) included in the new CGI and/or cell identity of the cell served by the second node is the same as an identifier of a base station to which the first node belongs.

For example, the fifth message is unable to be used to establish or re-establish the RRC connection to the second node, but also include the information used to update the cell served by the second node.

A sequence between S806 and S801 or S802 is not limited. S806 is performed before S801 and S802, or is performed before S801 and after S802, or is performed after S801 and S802.

It is noted that in this embodiment, a scenario in which the second node is directly connected to the first node is used as an example for description. This embodiment is also applicable to a scenario in which the second node is connected to the first node by using at least one other wireless backhaul device, in other words, the second node sends the second message to the first node by using at least one other wireless backhaul device.

According to some embodiments, in a scenario in which the RLF occurs on the second node, the second node is re-established from the source secondary base station to a new secondary base station, to reduce impact on the downstream node of the second node, and ensure normal working of the downstream node of the second node.

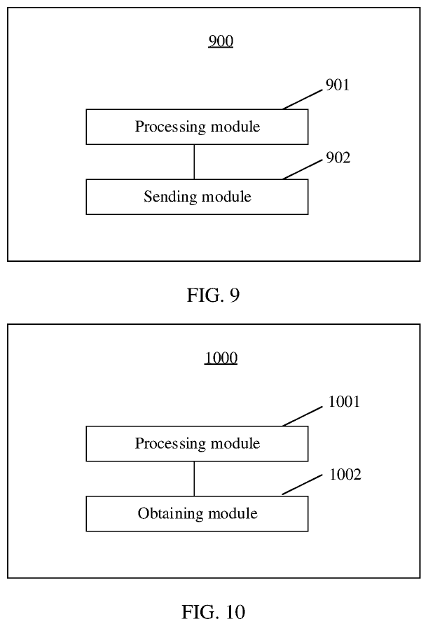

FIG. 9 is a schematic block diagram of a communication apparatus 900 according to some embodiments. The following specifically describes a structure and a function of the communication apparatus 900 with reference to FIG. 9. The communication apparatus 900 includes a processing module 901 and a sending module 902.

The processing module 901 is configured to determine that a radio link failure RLF occurs on a radio link between the apparatus and a second node, and there is no other available path between the apparatus and a destination node.

The sending module 902 is configured to send first indication information to a third node, where the first indication information indicates the RLF or indicates that a link recovery attempt is being made.

The second node is a parent node of a first node, and the third node is a child node of the first node; or

the second node is a child node of a first node, and the third node is a parent node of the first node or a donor node connected to the first node.

Optionally, in response to the second node being a parent node of the first node, and the third node is a child node of the first node, the sending module 902 is specifically configured to: in response to attempting to recover the radio link, send the first indication information to the third node, where the first indication information indicates that the link recovery attempt is being made.

Optionally, the sending module 902 is further configured to send second indication information to the third node, where the second indication information indicates that a path that passes through the first node to the destination node is unavailable.

Optionally, the second indication information includes a backhaul adaptation layer BAP address of the destination node, a routing identity routing ID corresponding to the path that passes through the first node to the destination node, or a path identity path ID corresponding to the path that passes through the first node to the destination node.

Optionally, that the second indication information indicates that a path that passes through the first node to the destination node is unavailable includes: The second indication information indicates that each path that passes through the first node to the destination node are unavailable;

the second indication information indicates that a path whose corresponding path ID is equal to the path ID included in the second indication information is unavailable in each path that passes through the first node to the destination node; or the second indication information indicates that a path whose corresponding routing ID is equal to the routing ID included in the second indication information is unavailable in each path that passes through the first node to the destination node.

Optionally, in response to the second node being a child node of the first node, and the third node is a donor node connected to the first node, the second indication information includes an identifier of the second node.

Optionally, that the second indication information indicates that a path that passes through the first node to the destination node is unavailable includes: The second indication information indicates that a path that includes the direct radio link between the first node and the second node is unavailable in each path that passes through the first node to the destination node.

FIG. 10 is a schematic block diagram of a communication apparatus 1000 according to some embodiments. The following specifically describes a structure and a function of the communication apparatus 1000 with reference to FIG. 10. The communication apparatus 1000 includes a processing module 1001 and an obtaining module 1002.

The obtaining module 1002 is configured to receive second indication information from a first node, where the second indication information indicates that a path that passes through the first node to a destination node is unavailable.

The processing module 1001 is configured to determine to route data to the destination node through another path.

Optionally, the obtaining module 1002 is further configured to receive first indication information from the first node, where the first indication information indicates an RLF or indicates that a link recovery attempt is being made.

Optionally, the second indication information includes a backhaul adaptation layer BAP address of the destination node, a routing identity routing ID corresponding to the path that passes through the first node to the destination node, or a path identity path ID corresponding to the path that passes through the first node to the destination node.

Optionally, the other path does not include the first node, a routing ID of the other path is not equal to the routing ID included in the second indication information, or a path ID of the other path is not equal to the path ID included in the second indication information.

Optionally, the second indication information includes an identifier of a second node, the second node is a child node of the first node, and the RLF occurs on a radio link between the first node and the second node.

Optionally, a routing ID of the other path is not equal to a routing ID corresponding to a path that passes through the first node to the destination node and that includes the direct radio link between the first node and the second node.

Optionally, the obtaining module 1002 is further configured to receive third indication information from the first node, where the third indication information indicates that radio link recovery succeeds.

The processing module 1001 is further configured to stop routing the data to the destination node through the other path.

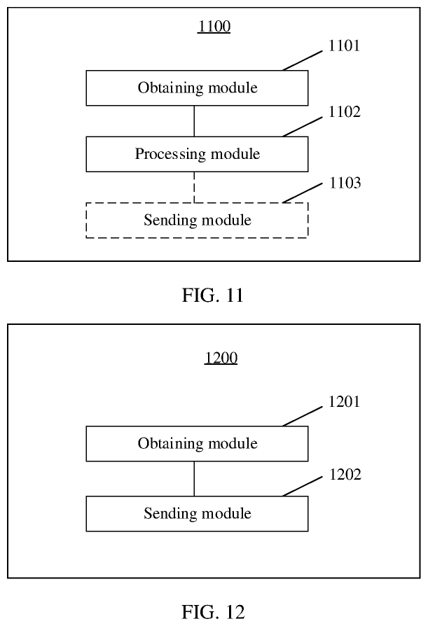

FIG. 11 is a schematic block diagram of a communication apparatus 1100 according to some embodiments. The following specifically describes a structure and a function of the communication apparatus 1100 with reference to FIG. 11. The communication apparatus 1100 includes an obtaining module 1101 and a processing module 1102, and optionally, further includes a sending module 1103.

The obtaining module 1101 is configured to receive a first message from a master base station of a fourth node, where the first message requests to add a first node as a secondary base station of the fourth node.

The first message includes: a physical cell identifier PCI of a cell that is of a second node and that is accessed by the fourth node and a cell radio network temporary identifier C-RNTI of the fourth node in the cell of the second node; or an identifier of a third node and an identifier of the fourth node on an interface between the third node and the first node, where the third node is a source secondary base station of the fourth node, and the fourth node is a downstream node of the second node.

The processing module 1102 is configured to obtain context information of the fourth node.

Optionally, before receiving the first message, the obtaining module 1101 is further configured to receive a second message from the second node, where the second message requests to establish or re-establish a radio resource control RRC connection to the second node; the sending module 1103 is configured to send a third message to the third node, where the third message requests to obtain context information related to the second node; the obtaining module 1101 is further configured to receive a fourth message from the third node, where the fourth message includes the context information related to the second node; and the sending module 1103 is further configured to send a fifth message to the second node, where the fifth message is used to establish or re-establish the RRC connection to the second node.

Optionally, the fifth message includes information used to update a cell served by the second node.

Optionally, the information used to update the cell served by the second node includes a global cell identifier CGI and/or a cell identity of the cell of the second node in response to the second node being connected to the first node.

Optionally, the context information related to the second node includes at least one of the following: context information of the second node, topology information between the second node and the fourth node, the context information of the fourth node, indication information indicating whether the second node is a wireless backhaul device, or indication information indicating whether the fourth node is a wireless backhaul device.

Optionally, the context information of the fourth node includes: the PCI and the C-RNTI; or the identifier of the third node and the identifier of the fourth node on the interface between the third node and the first node.

FIG. 12 is a schematic block diagram of a communication apparatus 1200 according to some embodiments. The following specifically describes a structure and a function of the communication apparatus 1200 with reference to FIG. 12. The communication apparatus 1200 includes an obtaining module 1201 and a sending module 1202.

The obtaining module 1201 is configured to receive a sixth message from a third node, where the sixth message requests to use a first node as a target secondary base station of a fourth node, and the third node is a source secondary base station of the fourth node.

The sending module 1202 is configured to send a first message to the first node, where the first message requests to add the first node as a secondary base station of the fourth node, and the first message includes: a physical cell identifier PCI of a cell that is of a second node and that is accessed by the fourth node and a cell radio network temporary identifier C-RNTI of the fourth node in the cell of the second node; or an identifier of the third node and an identifier of the fourth node on an interface between the third node and the first node.

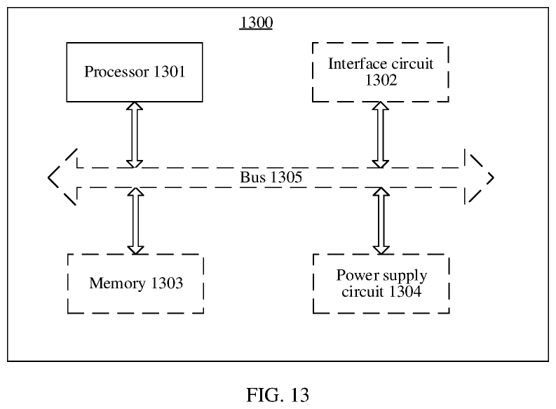

Based on a same technical concept, some embodiments, further provides an apparatus 1300. The following specifically describes a structure and a function of the apparatus 1300 with reference to a schematic block diagram of the apparatus 1300 in FIG. 13. The apparatus includes at least one processor 1301, and optionally, further includes an interface circuit 1302. In response to related program instructions being executed in the at least one processor 1301, the apparatus 1300 is enabled to implement the communication method provided in any one of the foregoing embodiments and the possible designs thereof. Alternatively, the processor 1301 is configured to implement, by using a logic circuit or executing code instructions, the communication method provided in any one of the foregoing embodiments and the possible designs thereof. The interface circuit 1302 is configured to: receive the program instructions and transmit the program instructions to the processor. Alternatively, the interface circuit 1302 is used by the apparatus 1300 to communicate and interact with another communication device, for example, exchange control signaling and/or service data with another communication device. For example, the interface circuit 1302 is configured to: receive a signal from an apparatus other than the apparatus 1300, and transmit the signal to the processor 1301; or send a signal from the processor 1301 to a communication apparatus other than the apparatus 1300. The interface circuit 1302 is a code and/or data read and write interface circuit, or the interface circuit 1302 is a signal transmission interface circuit between a communication processor and a transceiver. Optionally, the communication apparatus 1300 further includes at least one memory 1303, and the memory 1303 is configured to store the related program instructions and/or data that are/is desired. Optionally, the apparatus 1300 further includes a power supply circuit 1304. The power supply circuit 1304 is configured to supply power to the processor 1301. The power supply circuit 1304 and the processor 1301 is located in a same chip, or is located in a chip other than a chip in which the processor 1301 is located. Optionally, the apparatus 1300 further includes a bus 1305, and parts in the apparatus 1300 is interconnected through the bus 1305.

In some embodiments, the processor is a central processing unit (CPU), or the processor is another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor is a microprocessor or the processor is any conventional processor or the like.

In some embodiments, the memory is a volatile memory or a nonvolatile memory, or includes the volatile memory and the nonvolatile memory. The nonvolatile memory is a read-only memory (ROM), a programmable read-only memory (PROM), an erasable programmable read-only memory (EPROM), an electrically erasable programmable read-only memory (EEPROM), or a flash memory. The volatile memory is a random access memory (RAM), used as an external cache. By way of example but not limitation, many forms of random access memories (RAMs) are available, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), or a direct rambus random access memory (DR RAM).

The power supply circuit in some embodiments includes but is not limited to at least one of the following: a power supply line, a power supply subsystem, a power management chip, a power consumption management processor, or a power consumption management control circuit.

A transceiver apparatus, an interface circuit, or the transceiver in some embodiments include a separate transmitter and/or a separate receiver, or the transmitter and the receiver is integrated. The transceiver apparatus, the interface circuit, or the transceiver works under an indication of a corresponding processor. Optionally, the transmitter corresponds to a transmitter machine in a physical device, and the receiver corresponds to a receiver machine in the physical device.

A person skilled in the art that, for the purpose of convenient and brief description, division of the foregoing functional modules is used as an example for illustration. During application, the foregoing functions are allocated to different functional modules and implemented based on a condition, that is, an inner structure of an apparatus is divided into different functional modules to implement all or some of the functions described above. For a detailed working process of the foregoing system, apparatus, and unit, refer to a corresponding process in the foregoing method embodiments, and details are not described herein again.

In some embodiments, the disclosed systems, apparatuses, and methods are implemented in other manners. For example, the described apparatus embodiments are examples. For example, division into the modules or units is logical function division and is other division during implementation. For example, a plurality of units or components are combined or integrated into another system, or some features are ignored or not performed. In addition, the displayed or discussed mutual couplings or direct couplings or communication connections are implemented through some interfaces. The indirect couplings or communication connections between the apparatuses or units are implemented in electronic, mechanical, or other forms.

A person of ordinary skill in the art is aware that, in combination with examples described in the embodiments, units or algorithm operations are implemented by hardware, software, or a combination of software and hardware. Whether the functions are performed by hardware or software depends on particular applications and design constraints of the technical solutions. A person skilled in the art is able to use different methods to implement the described functions of each particular application, but consideration that the implementation goes beyond the scope of the embodiments is implausible.

In some embodiments, “implemented by software” means that a processor reads and executes program instructions stored in a memory to implement a function corresponding to the foregoing module or unit. The processor is a processing circuit that has a function of executing the program instructions, and includes but is not limited to at least one of the following: various types of processing circuits that executes the program instructions such as a central processing unit (CPU), a microprocessor, a digital signal processor (DSP), a microcontroller unit (MCU), or an artificial intelligence processor. In some other embodiments, the processor further includes a circuit that has another processing function (for example, a hardware circuit, a bus, and an interface circuit that are used for hardware acceleration). The processor is presented in a form of an integrated chip. For example, the processor is presented in a form of an integrated chip whose processing function includes a function of executing software instructions; or the processor is presented in a form of a system on a chip (SoC). On one chip, in addition to the processing circuit (which is usually referred to as a “core”) that executes the program instructions, another hardware circuit configured to implement a function is further included (where certainly, the hardware circuit further is independently implemented based on an ASIC or an FPGA). Correspondingly, in addition to the function of executing software instructions, processing functions further include various hardware acceleration functions (such as AI computing, encoding and decoding, and compression and decompression).

In some embodiments, “implemented by hardware” means that a function of the foregoing module or unit is implemented through a hardware processing circuit that does not have a function of processing program instructions. The hardware processing circuit includes a discrete hardware component, or is an integrated circuit. To reduce power consumption and a size, an integrated circuit is usually used for implementation. The hardware processing circuit includes an ASIC, or a programmable logic device (PLD). The PLD further includes an FPGA, a complex programmable logic device (CPLD), or the like. These hardware processing circuits are an independently packaged semiconductor chip (for example, packaged into an ASIC), or is integrated with another circuit (such as a CPU or a DSP) and then packaged into a semiconductor chip. For example, a plurality of hardware circuits and CPUs are formed on one silicon base, and are independently packaged into a chip, where the chip is also referred to as a SoC; or a circuit that is configured to implement an FPGA function and a CPU is formed on a silicon base, and are independently packaged into a chip, where the chip is also referred to as a system-on-a-programmable-chip (SoPC).

In some embodiments, in response to implementation by using software, hardware, or a combination of software and hardware, the embodiments are implemented by using different software and hardware, which is not limited to one type of software or hardware. For example, one of the modules or units are implemented through the CPU, and another module or unit is implemented through the DSP. Similarly, in response to hardware being used for implementation, one of the modules or units are implemented through the ASIC, and another module or unit is implemented through the FPGA. Certainly, that some or all modules or units are implemented by using a same type of software (for example, through the CPU) or a same type of hardware (for example, through the ASIC) is not specified. In addition, a person skilled in the art knows that, software usually has better flexibility but poorer performance than hardware, and hardware is opposite. Therefore, a person skilled in the art is able to select software, hardware, or a combination thereof for implementation based on a condition.

In the foregoing embodiments, the description of each embodiment has respective focuses. For a part that is not described in detail in an embodiment, refer to related descriptions in other embodiments. Embodiments are combined, or some technical features in embodiments are decoupled from embodiments and combined with a conventional technology, to resolve the technical problem in the embodiments.

In some embodiments, the units described as separate components are or are unable to be physically separate, and components displayed as units are or are unable to be physical units, is located in one position, or is distributed on a plurality of network units. Some or all of the units are selected based on conditions to achieve the objectives of the solutions of the embodiments.

In addition, functional units in some embodiments are integrated into one processing unit, or each of the units exists alone physically, or two or more units are integrated into one unit. The integrated unit is implemented in a form of hardware, or is implemented in a form of a software functional unit.

In response to the integrated unit being implemented in the form of a software functional unit and sold or used as an independent product, the integrated unit is stored in a computer-readable storage medium. Based on such an understanding, the technical solutions of the embodiments, or the part contributing to the conventional technology, or all or a part of the technical solutions are implemented in the form of a software product. The computer software product is stored in a storage medium and includes several instructions for instructing a computer device, for example, a personal computer, a server, a network device, or a processor to perform all or some of the operations of the methods described in the embodiments. The foregoing storage medium includes any medium or computer-readable storage medium that stores program code, such as a USB flash drive, a removable hard disk, a read-only memory (ROM), a random access memory (RAM), a magnetic disk, or an optical disc.

In some embodiments, terms such as “first”, “second”, “S201”, or “S202” are used for distinguishing and description and for ease of organizing this article. Different sequences or numbers do not have technical meanings, and is unable to be understood as indicating or implying relative importance, or indicating or implying an execution sequence of operations.

The term “and/or” in some embodiments describe an association relationship for associated objects, and indicates that three relationships exists. For example, “A and/or B” indicates the following three cases: A exists; both A and B exist; or B exists. A and B is singular or plural. In addition, the character “I” in the embodiments indicates an “or” relationship between the associated objects.

In some embodiments, “transmission” includes the following three cases: data sending, data receiving, or data sending and data receiving. In some embodiments, “data” includes service data and/or signaling data.

In some embodiments, the terms “include”, “have”, and any other variants thereof are intended to cover the non-exclusive inclusion. For example, a process/method that includes a series of steps or a system/product/device that includes a series of units is not limited to those expressly listed steps or units, but includes other steps or units not expressly listed or inherent to these processes/methods/products/devices.

In the descriptions of some embodiments, “at least one” represents one or more. “At least one of the following: A, B, and C is included” indicates that A is included, B is included, C is included, A and B are included, A and C are included, B and C are included, or A, B and C are included.

The solutions provided in some embodiments are applied to various communication systems, for example, a global system for mobile communications (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a worldwide interoperability for microwave access (WiMAX) communication system, a 5th generation (5G) mobile communication system, a new radio (NR) system, or another network system that is used to provide a mobile communication service. This is not limited in the embodiments.

The foregoing descriptions are implementations of the embodiments, but the protection scope of the embodiments is not limited thereto. Any variation or replacement readily figured out by a person skilled in the art within the technical scope disclosed in the embodiments shall fall within the protection scope of the embodiments.

1. An apparatus, comprises:
a processor; and
a memory operably coupled to the processor and configured to store a computer program, wherein the processor is configured to execute the computer program stored in the memory to cause the communication apparatus to perform operations to:
determine that a radio link failure (RLF) occurred on a radio link between a first node and a second node, and there is no other available path between the first node and a destination node; and
send a first indication information to a third node, wherein the first indication information indicates that a link recovery attempt is being made, wherein:
the second node is a parent node of the first node, and the third node is a child node of the first node; or
the second node is the child node of the first node, and the third node is the parent node of the first node or a donor node connected to the first node.

2. The apparatus according to claim 1, wherein the second node being a parent node of the first node, and the third node is a child node of the first node, and the communication apparatus performs operations to:
in response to an attempt to recover the radio link, send the first indication information to the third node, wherein the first indication information indicates that the link recovery attempt is being made.

3. The apparatus according to claim 1, wherein the communication apparatus further performs operations to:
send second indication information to the third node, wherein the second indication information indicates that a path that passes through the first node to the destination node is unavailable.

4. The apparatus according to claim 3, wherein:
the second indication information includes:
a backhaul adaptation protocol (BAP) layer address of the destination node;
a routing identity (routing ID) corresponding to the path that passes through the first node to the destination node or
a path identity (path ID) corresponding to the path that passes through the first node to the destination node.

5. The apparatus according to claim 4, wherein:
the second indication information further includes:
indicates that each path that passes through the first node to the destination node are unavailable;
a path whose corresponding path ID is equal to the path ID included in the second indication information is unavailable in each path that passes through the first node to the destination node; or
a path whose corresponding routing ID is equal to the routing ID included in the second indication information is unavailable in each path that passes through the first node to the destination node.

6. The apparatus according to claim 3, wherein:
the second node is the child node of the first node, and the third node is the donor node connected to the first node, the second indication information includes an identifier of the second node.

7. The apparatus according to claim 6, wherein the second indication information that indicates the a path that passes through the first node to the destination node is unavailable includes:
information that a path that includes a direct radio link between the first node and the second node is unavailable in each path that passes through the first node to the destination node.

8. An apparatus, comprises:
a processor; and
a memory operably coupled to the processor and configured to store a computer program, wherein the processor is configured to execute the computer program stored in the memory to cause the apparatus to perform operations to:
receive first indication information from a first node, wherein the first indication information indicates that a link recovery attempt is being made; and
determine to route data to a destination node through an alternate path.

9. The apparatus according to claim 8, wherein the apparatus further performs operations to:
receive second indication information from the first node, wherein the second indication information indicates that a path that passes through the first node to the destination node is unavailable.

10. The apparatus according to claim 9, wherein:
the second indication information includes:
a backhaul adaptation protocol (BAP) layer address of the destination node
a routing identity (routing ID) corresponding to the path that passes through the first node to the destination node; or
a path identity (path ID) corresponding to the path that passes through the first node to the destination node.

11. The apparatus according to claim 10, wherein:
the alternate path does not includes the first node;
a routing ID of the alternate path is not equal to the routing ID included in the second indication information; or
a path ID of the alternate path is not equal to the path ID included in the second indication information.

12. The apparatus according to claim 9, wherein:
the second indication information includes:
an identifier of a second node;
the second node is a child node of the first node; and
a radio link failure (RLF) occurred on a radio link between the first node and the second node.

13. The apparatus according to claim 12, wherein:
a routing ID of the alternative path is not equal to a routing ID corresponding to the path that passes through the first node to the destination node and that includes a direct radio link between the first node and the second node.

14. The apparatus according to claim 8, wherein the apparatus further performs operations to:
receive third indication information from the first node, wherein the third indication information indicates that radio link recovery is successful; and
stop routing the data to the destination node through the alternative path.

15. A communication system, comprises:
a first node; and
a second node;
wherein the first node is configured to:
determine that a radio link failure (RLF) occurs on a radio link between the first node and a third node, and there is no other available path between the first node and a destination node; and
send first indication information to the second node, wherein the first indication information indicates that a link recovery attempt is being made, wherein:
the third node is a parent node of the first node, and the second node is a child node of the first node; or
the third node is the child node of the first node, and the second node is the parent node of the first node or a donor node connected to the first node;
wherein the second node is configured to:
receive the first indication information from the first node; and
determine whether to route data to the destination node through an alternate path.

16. The communication system according to claim 15, wherein:
the third node is the parent node of the first node, and the second node is child node of the first node, wherein:
the first node is configured to, in response to an attempt to recover the radio link, send the first indication information to the second node, wherein the first indication information indicates that the link recovery attempt is being made.

17. The communication system according to claim 15, wherein:
the first node is further configured to send second indication information to the second node, wherein the second indication information indicates that radio link recovery is successful.

18. The communication system according to claim 15, wherein:
the second node is further configured to:
receive second indication information from the first node, wherein the second indication information indicates that radio link recovery is successful; and
stop routing the data to the destination node through the alternative path.

19. The communication system according to claim 15, wherein:
the first node is further configured to send third indication information to the second node, wherein the third indication information indicates that a path that passes through the first node to the destination node is unavailable.

20. The communication system according to claim 19, wherein:
the third indication information includes:
a backhaul adaptation protocol (BAP) layer address of the destination node;
a routing identity (routing ID) corresponding to the path that passes through the first node to the destination node; or
a path identity (path ID) corresponding to the path that passes through the first node to the destination node.
